(19) United States
(12) Patent Application Publication
(10) Pub. No.: US 2024/0166810 A1
(43) Pub. Date: May 23, 2024

(54) POLYARYLENE ETHER KETONE RESIN, PRODUCTION METHOD FOR SAME, AND MOLDED PRODUCT

(71) Applicant: ASAHI KASEI KABUSHIKI KAISHA, Chiyoda-ku, Tokyo (JP)

(72) Inventors: Yuji WATANABE, Chiyoda-ku, Tokyo (JP); Michihiro ISHIHARA, Chiyoda-ku, Tokyo (JP); Masami YONEMURA, Chiyoda-ku, Tokyo (JP)

(73) Assignee: ASAHI KASEI KABUSHIKI KAISHA, Chiyoda-ku, Tokyo (JP)

(21) Appl. No.: 18/548,252

(22) PCT Filed: Mar. 25, 2022
(86) PCT No.: PCT/JP2022/014662

§ 371 Date: Aug. 29, 2023

(30) Foreign Application Priority Data
Mar. 25, 2021 (JP) 2021-052321
Mar. 29, 2021 (JP) 2021-055851

(51) Int. Cl. C08G 65/40

(52) U.S. Cl. CPC C08G 65/40; C08G 2120/00; C08G 2650/62

(57) ABSTRACT

Provided is a polyarylene ether ketone resin, wherein a GPC-based number average molecular weight Mn is 6000 or more and less than 16000, a molecular weight distribution Mw/Mn represented by a ratio of a GPC-based weight average molecular weight Mw to the number average molecular weight Mn is 2.5 or less, and in all repeating units contained in the resin, ketone groups are 9.5 mol % or more and ether groups are 4.5 mol % or more.

### TECHNICAL FIELD

The present disclosure relates to a polyarylene ether ketone resin, a production method for the same, and a molded product containing the polyarylene ether ketone resin.

### BACKGROUND

Polyarylene ether ketone resins (hereinafter also simply referred to as PAEK resins) are super engineering plastics excellent in heat resistance and toughness and continuously usable in high-temperature environments, and have a wide range of applications including medical parts and fibers as well as transportation apparatuses such as automobile parts and members for aircrafts. In particular, their excellent chemical resistance makes them suited for use in the semiconductor field in which a number of washing steps are required, and their excellent self-extinguishing characteristic and flame resistance (substantially equivalent to V-0) in the neat resin state make them widely used in applications of electrical and electronic materials.

The techniques described in PTL 1 and PTL 2 are known as a PAEK resin and a PAEK resin-containing polymer composition having excellent mechanical properties.

It is known that conventional methods of producing PAEK resins are broadly classified into (a) methods using aromatic electrophilic substitution reactions and (b) methods using aromatic nucleophilic substitution reactions.

As the methods (a), for example, PTL 3 discloses a method of producing a polyether ketone ketone resin (hereinafter also simply referred to as PEKK resin) through an aromatic electrophilic substitution type polycondensation reaction by using two kinds of monomers, i.e. terephthalic acid dichloride and diphenyl ether, and causing a Lewis acid to act in o-dichlorobenzene.

For example, PTL 4 discloses a method of producing a PAEK resin through an aromatic electrophilic substitution type polycondensation reaction by causing an acid anhydride having a pKa of 0 or less in a solvent to act in a mixture of an aromatic dicarboxylic acid or a derivative thereof and a compound having an aromatic ether skeleton or an aromatic thioether skeleton.

For example, the specification of PTL 5 discloses a method of producing a polyether ketone ketone resin through an aromatic electrophilic substitution type polycondensation reaction by using two kinds of monomers, i.e. terephthalic acid dichloride and diphenyl ether, and causing an inorganic Lewis acid to act.

As the methods (b), for example, PTL 6 discloses a method of producing a polyether ether ketone resin (hereinafter also simply referred to as PEEK resin) through an aromatic nucleophilic substitution type polycondensation reaction by using two kinds of monomers, i.e. 4,4′-difluorobenzophenone and hydroquinone, and causing potassium carbonate to act in diphenylsulfone.

For example, PTL 7 discloses a method of producing a polyether ketone ketone resin through an aromatic nucleophilic substitution type polycondensation reaction of 1,4-bis(4′-fluorobenzoyl)benzene or 1,3-bis(4′-fluorobenzoyl)benzene and 1,4-bis(4′-hydroxybenzoyl)benzene or 1,3-bis(4′-hydroxybenzoyl)benzene in the presence of an alkali metal carbonate, optionally with the addition of lithium chloride, in a solvent such as diphenylsulfone which is at the melting point or less at room temperature and atmospheric pressure.

### CITATION LIST

### Patent Literature

PTL 1: WO 2019/142942 A1
PTL 2: JP 2019-524943 A
PTL 3: JP 2020-520360 A
PTL 4: JP 2020-143262 A
PTL 5: Specification of U.S. Pat. No. 3,065,205 A
PTL 6: JP S54-090296 A
PTL 7: JP 2020-502325 A

### SUMMARY

### Technical Problem

With the foregoing conventional synthesis methods, however, it is difficult to synthesize a PAEK resin that has both a high molecular weight and a narrow molecular weight distribution.

With the conventional PAEK resins, outgassing occurs during high-temperature heating due to the influence of low molecular weight components derived from a wide molecular weight distribution. When outgassing occurs, air bubbles mix in the molded product upon molding. This deteriorates the appearance and, when the molded product is used at high temperatures, contaminates (oxidizes) the surrounding metals and electronic parts, resulting in discoloration or degeneration.

It could therefore be helpful to provide a PAEK resin having a high molecular weight, a narrow molecular weight distribution, and excellent molding processability and strength, a production method for the same, and a molded product containing the PAEK resin and having little outgassing during high-temperature heating.

### Solution to Problem

We thus provide:
(1) A polyarylene ether ketone resin, wherein a GPC-based number average molecular weight Mn is 6000 or more and less than 16000, a molecular weight distribution Mw/Mn represented by a ratio of a GPC-based weight average molecular weight Mw to the number average molecular weight Mn is 2.5 or less, and in all repeating units contained in the resin, ketone groups are 9.5 mol % or more and ether groups are 4.5 mol % or more.
(2) The polyarylene ether ketone resin according to (1), wherein the number average molecular weight Mn is 6000 or more and less than 13000, and the molecular weight distribution Mw/Mn is 2.4 or less.
(3) The polyarylene ether ketone resin according to (1) or (2), wherein when differential scanning calorimetry is performed by a conditional program of increasing from 50° C. to 400° C. under a temperature increase condition of 20° C./min and decreasing from 400° C. to 50° C. under a temperature decrease condition of 20° C./min in accordance with ASTM D3418, a crystal melting point (Tm) and a crystallization temperature (Tc) detected in a second program cycle after measurement start satisfy the following relationship:

60° C.≤(Tm−Tc)≤100° C.
(4) The polyarylene ether ketone resin according to any one of (1) to (3), comprising a repeating unit (1-1) represented by the following general formula (1-1) and optionally further comprising a repeating unit (2-1) represented by the following general formula (2-1), wherein a ratio of the repeating unit (1-1) and the repeating unit (2-1), expressed as the repeating unit (1-1):the repeating unit (2-1), is in a range of 100:0 to 50:50 in molar ratio,

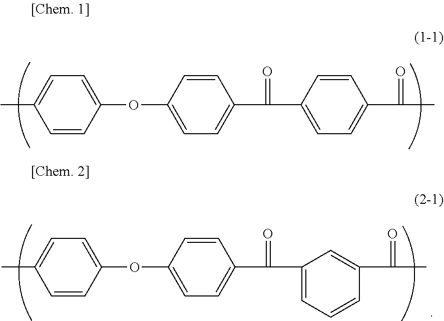

(5) The polyarylene ether ketone resin according to any one of (1) to (4), wherein a glass transition temperature is 140° C. or more, and a melting point is 300° C. or more.
(6) The polyarylene ether ketone resin according to any one of (1) to (5), wherein a fluorine atom content is 1500 mass ppm or less.
(7) The polyarylene ether ketone resin according to any one of (1) to (6), wherein in a differential molecular weight distribution curve obtained by GPC measurement, a ratio of an area of a part in which a molecular weight logarithmic value log M is 3.4 or less to an area of the entire curve is less than 8%, where M is a molecular weight.
(8) The polyarylene ether ketone resin according to any one of (1) to (7), wherein a tensile breaking strength is 110 MPa to 145 MPa.
(9) The polyarylene ether ketone resin according to any one of (1) to (8), wherein a Charpy impact strength is 5 kJ/m² or more.
(10) The polyarylene ether ketone resin according to any one of (1) to (9), wherein a ratio of the repeating unit (1-1) and the repeating unit (2-1), expressed as the repeating unit (1-1):the repeating unit (2-1), is in a range of 85:15 to 55:45 in molar ratio.
(11) The polyarylene ether ketone resin according to any one of (1) to (10), wherein when differential scanning calorimetry is performed by a conditional program of increasing from 50° C. to 400° C. under a temperature increase condition of 20° C./min and decreasing from 400° C. to 50° C. under a temperature decrease condition of 20° C./min in accordance with ASTM D3418, a crystal melting enthalpy change (ΔH) detected in a second program cycle after measurement start is 30 J/g or more.
(12) The polyarylene ether ketone resin according to any one of (1) to (11), wherein the crystallization temperature (Tc) is 220° C. or more.
(13) A production method for a polyarylene ether ketone resin, comprising reacting a monomer component containing a monomer having a phthaloyl skeleton with a Lewis acid or a Broensted acid anhydride catalyst in a solvent at 10° C. or more for 1 hour or more, and thereafter adding diphenyl ether (3-1) represented by the following general formula (3-1) to a resultant reaction product to react with the reaction product, wherein in the polyarylene ether ketone resin, a GPC-based number average molecular weight Mn is 6000 or more and less than 16000, a molecular weight distribution Mw/Mn represented by a ratio of a GPC-based weight average molecular weight Mw to the number average molecular weight Mn is 2.5 or less, and in all repeating units contained in the resin, ketone groups are 9.5 mol % or more and ether groups are 4.5 mol % or more,

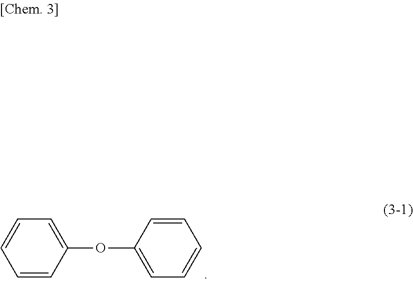

(14) The production method for a polyarylene ether ketone resin according to (13), wherein the monomer component containing the monomer having the phthaloyl skeleton is a monomer component that contains a monomer (1-2) having a terephthaloyl skeleton represented by the following general formula (1-2) and optionally further contains a monomer (2-2) having an isophthaloyl skeleton represented by the following general formula (2-2),

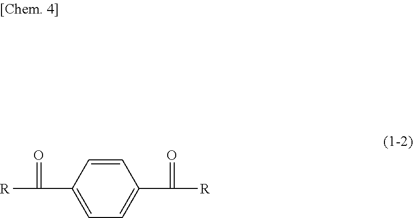

where R may be same or different, and are each a halogen atom or a hydroxy group,

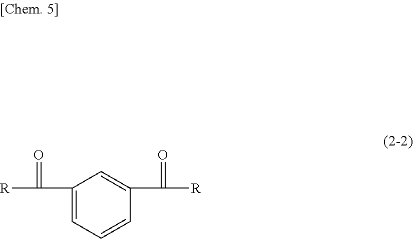

where R may be same or different, and are each a halogen atom or a hydroxy group.
(15) The production method for a polyarylene ether ketone resin according to (13) or (14), wherein the Lewis acid is aluminum chloride.
(16) The production method for a polyarylene ether ketone resin according to any one of (13) to (15), wherein the Broensted acid anhydride catalyst is trifluoroacetic anhydride.
(17) The production method for a polyarylene ether ketone resin according to any one of (13) to (16), wherein the solvent is o-dichlorobenzene, chloroform, dichloromethane, trifluoromethanesulfonic acid, or trifluoroacetic acid.
(18) A composition comprising the polyarylene ether ketone resin according to any one of (1) to (12).
(19) A molded product comprising the polyarylene ether ketone resin according to any one of (1) to (12) or the composition according to (18).

### Advantageous Effect

It is thus possible to provide a PAEK resin having a high molecular weight, a narrow molecular weight distribution, and excellent molding processability and strength, a production method for the same, and a molded product containing the PAEK resin and having little outgassing during high-temperature heating.

### DETAILED DESCRIPTION

An embodiment of the present disclosure (hereinafter simply referred to as “this embodiment”) will be described in detail below. The embodiment described below is merely an example for describing the presently disclosed techniques and is not intended to limit the present disclosure to the following contents. The present disclosure can be implemented with appropriate modifications that do not deviate from the essence thereof.

### Polyarylene Ether Ketone Resin (PAEK Resin)

A PAEK resin according to this embodiment has: a GPC-based number average molecular weight Mn of 6000 or more and less than 16000; and a molecular weight distribution Mw/Mn, represented by the ratio of a GPC-based weight average molecular weight Mw to the number average molecular weight Mn, of 2.5 or less, wherein in all repeating units contained in the resin, ketone groups are 9.5 mol % or more and ether groups are 4.5 mol % or more.

The PAEK resin according to this embodiment having a narrow molecular weight distribution has an improved color tone as compared with a PAEK resin having a wide molecular weight distribution, and has high versatility when molded. Since the PAEK resin according to this embodiment has a narrow molecular weight distribution, the content of low molecular weight components is low and crystallization is facilitated, and outgassing due to volatilization of low molecular weight components during high-temperature heating is reduced. In addition, since the molecular weight distribution is narrow, the content of high molecular weight components is also low, so that the molding processability is improved.

The PAEK resin according to this embodiment preferably contains a repeating unit (1-1) represented by the following general formula (1-1), and may further contain a repeating unit (2-1) represented by the following general formula (2-1). The PAEK resin according to this embodiment is more preferably a resin consisting only of the repeating unit (1-1), or consisting only of the repeating unit (1-1) and the repeating unit (2-1).

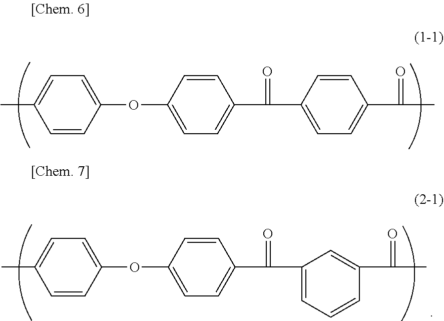

The PAEK resin according to this embodiment preferably has a structure having end groups E represented by the following general formula (7-1), (7-2), (7-3), or (7-4), to a structure containing the repeating unit (1-1) or a structure containing a combination of the repeating unit (1-1) and the repeating unit (2-1) (preferably, a structure consisting only of the repeating unit (1-1) or a structure consisting only of the repeating unit (1-1) and the repeating unit (2-1)).

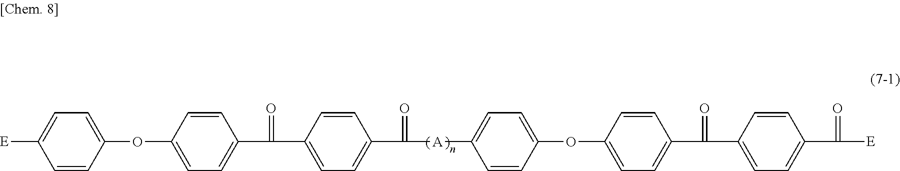

where A may be a structure containing the repeating unit (1-1) or a structure containing a combination of the repeating unit (1-1) and the repeating unit (2-1), and n is an integer of 1 or more.

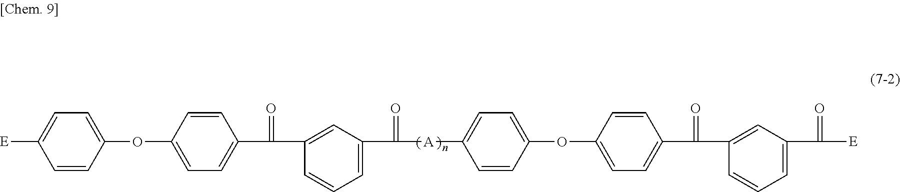

where A may be a structure containing the repeating unit (1-1) or a structure containing a combination of the repeating unit (1-1) and the repeating unit (2-1), and n is an integer of 1 or more.

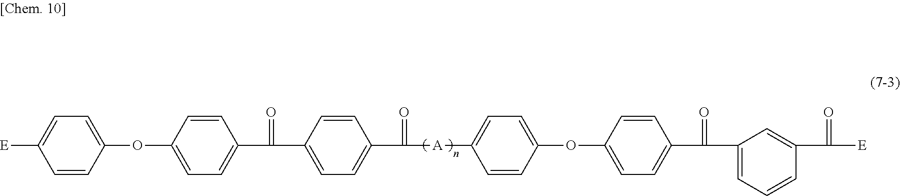

where A may be a structure containing the repeating unit (1-1) or a structure containing a combination of the repeating unit (1-1) and the repeating unit (2-1), and n is an integer of 1 or more.

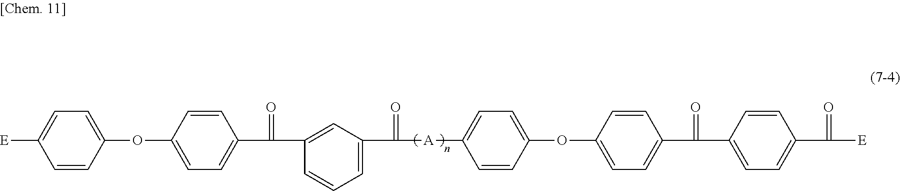

where A may be a structure containing the repeating unit (1-1) or a structure containing a combination of the repeating unit (1-1) and the repeating unit (2-1), and n is an integer of 1 or more.

The left and right E in general formulas (7-1), (7-2), (7-3), and (7-4) may be the same or different, and are each selected as a monovalent substituent, for example, may be selected from the group consisting of substituents represented by the following general formula (7-5) and substituents represented by the following general formula (7-6).

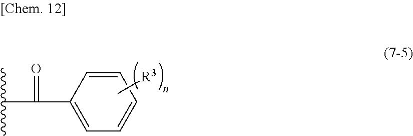

where n is an integer of 0 to 5, and R³ may be the same or different, and are each a hydrogen atom, —COOR⁴, —SO₂R⁴, —SO₃R⁴, or an alkyl group or substituted aryl group selected from an atomic group having part or all of a carbon atom, an oxygen atom, a sulfur atom, a nitrogen atom, and a hydrogen atom as constituent elements, having a carbon number of 1 to 20, and free of protonic substituent. R⁴ is a monovalent substituent, and is a hydrogen atom or an alkyl group or substituted aryl group selected from an atomic group having part or all of a carbon atom, an oxygen atom, a sulfur atom, a nitrogen atom, and a hydrogen atom as constituent elements, having a carbon number of 1 to 20, and free of protonic substituent.

The substitution position of R³ may be any combination, but is preferably a combination having C₂ symmetry when a rotation around the single bond between the carbonyl carbon and the aromatic ring carbon in general formula (7-5) is taken into consideration.

In the present disclosure, “protonic substituents” refer to hydroxyl groups, aldehyde groups (—CHO), carboxyl groups (—COOH), and primary or secondary amines, for example.

The substitution position of R³ may be any combination, but is preferably a combination having C₂ symmetry when a rotation around the single bond between the carbonyl carbon and the aromatic ring carbon in general formula (7-5) is taken into consideration.

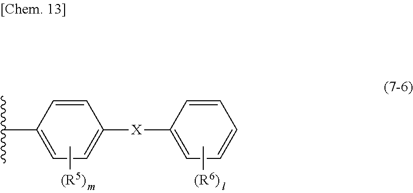

where m is an integer of 0 to 4, 1 is an integer of 0 to 5, X is an oxygen atom, a sulfur atom, —CH₂—, or 1,4-dioxybenzene unit, and R⁵ and R⁶ may be the same or different, and are each a hydrogen atom, —COOR⁴, —SO₂R⁴, —SO₃R⁴, or an alkyl group or substituted aryl group selected from an atomic group having part or all of a carbon atom, an oxygen atom, a sulfur atom, a nitrogen atom, and a hydrogen atom as constituent elements, having a carbon number of 1 to 20, and free of protonic substituent. R⁴ is a monovalent substituent, and is a hydrogen atom or an alkyl group or substituted aryl group selected from an atomic group having part or all of a carbon atom, an oxygen atom, a sulfur atom, a nitrogen atom, and a hydrogen atom as constituent elements, having a carbon number of 1 to 20, and free of protonic substituent.

Each of the substitution positions of R⁵ and R⁶ may be any combination, but is preferably a combination having C₂ symmetry when a rotation around the single bond between the aromatic ring carbon and X in general formula (7-6) is taken into consideration.

In the present disclosure, “protonic substituents” refer to hydroxyl groups, aldehyde groups (—CHO), carboxyl groups (—COOH), and primary or secondary amines, for example.

The left and right E in formulas (7-1), (7-2), (7-3), and (7-4) each have its suitability depending on the application in which the PAEK resin according to this embodiment is used, and the selections are not limited to this example.

For example, when the thermal stability of the PAEK resin according to this embodiment and the reactivity by gas generation upon heating or any thermal reaction which may cause a structural change inside the repeating units are taken into consideration, E is preferably a substituent wherein R³ is selected from atoms or atomic groups free of a carboxyl group (—COOH) among the substituents represented by general formula (7-5) or a substituent represented by general formula (7-6), and more preferably a substituent wherein R³ is selected from atoms or atomic groups free of a carboxyl group (—COOH) and a sulfo group (—SO₃H) among the substituents represented by general formula (7-5).

When use of the PAEK resin according to this embodiment in combination with other resins or materials via covalent bonding or single intermolecular interaction or any combination of intermolecular interactions is taken into consideration, E is preferably a substituent wherein R³ is selected from atoms or atomic groups containing a carboxyl group (—COOH) or a sulfo group (—SO₃H) among the substituents represented by general formula (7-5).

Appropriate selection of the ratio (e.g. molar ratio) of the rigid repeating unit (1-1) and the flexible repeating unit (2-1) enables the melting point (hereafter also referred to as crystal melting point) (Tm) of the PAEK resin according to this embodiment to be adjusted while retaining high crystallinity, thereby imparting good molding processability.

The ratio of the repeating unit (1-1) and the repeating unit (2-1) (repeating unit (1-1):repeating unit (2-1)) is preferably in the range of 100:0 to 50:50, more preferably in the range of 90:10 to 55:45, further preferably in the range of 85:15 to 60:40, and particularly preferably in the range of 85:15 to 65:35 in molar ratio. By increasing the molar ratio of the repeating unit (1-1) within the foregoing molar ratio range, the glass transition temperature (Tg), the crystallinity, and the melting point (Tm) can be increased and a PAEK resin excellent in heat resistance can be obtained. By decreasing the molar ratio of the repeating unit (1-1) within the foregoing molar ratio range, the melting point (Tm) can be adjusted to a relatively low temperature and a PAEK resin excellent in molding processability can be obtained.

As a result of appropriately optimizing the ratio of the repeating unit (1-1) and the repeating unit (2-1) and adjusting the degree of polymerization to obtain a number average molecular weight Mn in a specific range, the PAEK resin according to this embodiment can have excellent heat resistance, molding processability, and molded product strength.

The PAEK resin according to this embodiment may contain repeating units other than the repeating unit (1-1) and the repeating unit (2-1) within the range that does not impair the effects according to the present disclosure. In the case where the PAEK resin contains other repeating units, the other repeating units are preferably 50 mol % or less where the total of the repeating unit (1-1), the repeating unit (2-1), and the other repeating units is 100 mol %.

The number average molecular weight Mn of the PAEK resin according to this embodiment is 6000 or more and less than 16000, preferably 6000 to 15500, more preferably 6000 to 15000, further preferably 7000 to 14000, and particularly preferably 8000 or more and less than 13000.

As a result of the number average molecular weight being not more than the foregoing upper limit, appropriate fluidity is exhibited during molding, contributing to excellent processability. As a result of the number average molecular weight being not less than the foregoing lower limit, a molded product excellent in mechanical properties such as strength can be obtained.

The molecular weight distribution Mw/Mn of the PAEK resin according to this embodiment, represented by the ratio of the weight average molecular weight Mw to the number average molecular weight Mn, is 2.5 or less, preferably 1.2 to 2.5, more preferably 1.3 to 2.4, further preferably 1.3 to 2.2, and particularly preferably 1.4 to 1.9.

As a result of the molecular weight distribution being in the foregoing range, a molded product excellent in mechanical properties such as strength can be obtained.

The number average molecular weight and the weight average molecular weight are values measured using GPC, and specifically can be measured by the method described in the EXAMPLES section below.

In a differential molecular weight distribution curve (graph of differential molecular weight distribution) of the PAEK resin according to this embodiment obtained by GPC measurement, the ratio of the area of the part (low molecular weight component part) in which the molecular weight logarithmic value log M (where M is the molecular weight) as the horizontal axis is 3.4 or less to the area of the entire curve (entire graph) is preferably less than 8%, more preferably 6% or less, and further preferably 4% or less. No lower limit is placed on the ratio of the area of the part in which log M is 3.4 or less, and the ratio may be 0% or more, or 0.1% or more. As a result of the ratio of the area of the part in which log M is 3.4 or less being in the foregoing range, the content of low molecular weight components is low, and outgassing due to volatilization of low molecular weight organic components during high-temperature heating is reduced. Moreover, crystallization is facilitated.

Specifically, the ratio of the area of the part in which log M is 3.4 or less can be measured by the method described in the EXAMPLES section below.

The intrinsic viscosity of the PAEK resin according to this embodiment is preferably 0.58 dL/g to 3.00 dL/g, more preferably 0.6 dL/g to 2.80 dL/g, and particularly preferably 0.62 dL/g to 2.7 dL/g. If the intrinsic viscosity is not more than the foregoing upper limit, the PAEK resin tends to have excellent molding processability.

The intrinsic viscosity is a value measured in accordance with ASTM D2857 at a test temperature of 30° C. using a 0.5 mass/vol % solution of the PAEK resin in 96% H₂SO₄ as a test solution.

The glass transition temperature (Tg) of the PAEK resin according to this embodiment is preferably 120° C. to 190° C., more preferably 122° C. to 188° C., further preferably 125° C. to 185° C., still further preferably 127° C. to 175° C., still further preferably 130° C. to 170° C., particularly preferably 135° C. to 170° C., and most preferably 140° C. to 170° C.

The glass transition temperature can be adjusted, for example, by appropriately selecting the ratio of the repeating unit (1-1) and the repeating unit (2-1).

The glass transition temperature can be measured by the method described in the EXAMPLES section below.

The melting point (Tm) of the PAEK resin according to this embodiment is preferably 250° C. to 400° C., more preferably 260° C. to 390° C., further preferably 270° C. to 390° C., still further preferably 300° C. to 390° C., still further preferably 300° C. to 385° C., and particularly preferably 310° C. to 385° C.

The melting point can be adjusted, for example, by appropriately selecting the ratio of the repeating unit (1-1) and the repeating unit (2-1).

The melting point can be measured by the method described in the EXAMPLES section below.

The crystallization temperature (Tc) of the PAEK resin according to this embodiment is preferably 220° C. to 310° C., more preferably 220° C. to 305° C., and further preferably 220° C. to 300° C.

The crystallization temperature (Tc) can be adjusted, for example, by appropriately selecting the ratio of the repeating unit (1-1) and the repeating unit (2-1) as mentioned above.

The crystallization temperature (Tc) can be measured by the method described in the EXAMPLES section below.

The difference (Tm−Tc) between the crystal melting point (Tm) and the crystallization temperature (Tc) of the PAEK resin according to this embodiment is preferably 100° C. or less, more preferably 98° C. or less, further preferably 96° C. or less, and most preferably 91° C. or less.

Since the crystallization temperature (Tc) is close to the crystal melting point (Tm), the heat resistance is high, and the molded product has excellent dimensional stability after reflow, which is preferable.

Our careful examination revealed that setting Tm−Tc to 100° C. or less enables the PAEK resin to have excellent chemical resistance. The reason for this is not clear, but is presumed as follows: Given that Tm−Tc denotes the crystallization rate, fast crystallization rate means that the crystal structure of the PAEK resin according to this embodiment is different from that of existing PAEK resin, and this effect contributes to excellent chemical resistance.

The difference (Tm−Tc) between the crystal melting point (Tm) and the crystallization temperature (Tc) of the PAEK resin according to this embodiment is preferably 60° C. or more, more preferably 62° C. or more, further preferably 64° C. or more, still further preferably 70° C. or more, and particularly preferably 74° C. or more.

If (Tm−Tc) is 60° C. or more, excellent moldability is achieved with no sink marks, etc. in the molded product, which is preferable. If (Tm−Tc) is 64° C. or more, the injection cycle time during molding is shortened while maintaining the moldability and the productivity of molded products is excellent, which is more preferable. If (Tm−Tc) is 70° C. or more, the injection cycle time during molding is further shortened while maintaining the moldability and the productivity of molded products is excellent, which is further preferable. (Tm−Tc) is particularly preferably 74° C. or more.

The difference (Tm−Tc) between the crystal melting point (Tm) and the crystallization temperature (Tc) can be adjusted, for example, by adjusting the amount of trace elements (Al, F, Cl, etc.) in the PAEK resin. (Tm−Tc) tends to be greater when the content of trace elements is higher.

The crystallinity of the PAEK resin according to this embodiment is preferably 23% to 50%, more preferably 23% to 48%, and further preferably 23% to 46%.

The crystallinity can be adjusted, for example, by appropriately selecting the ratio of the repeating unit (1-1) and the repeating unit (2-1) as mentioned above.

The crystallinity is a value calculated by the following formula using the crystal melting enthalpy change ΔH detected in the second program cycle after the measurement start when differential scanning calorimetry is performed by a conditional program of increasing from 50° C. to 400° C. under a temperature increase condition of 20° C./min and decreasing from 400° C. to 50° C. under a temperature decrease condition of 20° C./min in accordance with ASTM D3418.

Crystallinity (%)=ΔH/ΔHc×100
where ΔH is the crystal melting enthalpy change of the PAEK resin, and ΔHc is 130 J/g which is the melting calorie of the perfect crystal of the PEEK resin.

The crystal melting enthalpy change (ΔH) of the PAEK resin according to this embodiment is preferably 30 J/g to 65 J/g, more preferably 30 J/g to 63 J/g, and further preferably 30 J/g to 60 J/g.

The crystal melting enthalpy change (ΔH) can be adjusted, for example, by adjusting the amount of trace elements (Al, F, Cl, etc.) in the PAEK resin. ΔH tends to be smaller when the content of trace elements is higher.

The crystal melting enthalpy change (ΔH) can be measured by the method described in the EXAMPLES section below.

In all repeating units contained the PAEK resin according to this embodiment, ketone groups are 9.5 mol % or more and ether groups are 4.5 mol % or more.

As a result of the number of ketone groups and the number of ether groups in all repeating units contained in the PAEK resin according to this embodiment satisfying the foregoing range, a molded product excellent in mechanical properties such as strength can be obtained.

The Al atom content per 100 mass % of the PAEK resin according to this embodiment is preferably 100 mass ppm or less, more preferably 90 ppm or less, and further preferably 80 ppm or less. If the Al atom content is in the foregoing range, Tm−Tc tends to be easily adjusted within the foregoing specific range. This is considered to be because a trace amount of Al element serves as crystal nuclei and influences the crystallization temperature (Tc).

The Al atom content can be measured in the following manner: About 0.1 g of the PAEK resin sample is precisely weighed out in a decomposition vessel made of tetrafluoromethoxyl (TFM), and pressurized acid decomposition is performed by adding sulfuric acid and nitric acid in a microwave decomposition apparatus. The resultant decomposed solution is adjusted to a volume to 50 mL, which is subjected to ICP-MS measurement. Specifically, the Al atom content can be measured by the method described in the EXAMPLES section below.

The fluorine atom content per 100 mass % of the PAEK resin according to this embodiment is preferably 1500 mass ppm or less, more preferably 1000 ppm or less, further preferably 500 ppm or less, and most preferably 200 ppm or less. If the fluorine atom content is in the foregoing range, outgassing due to volatilization of residual components during high-temperature heating tends to be reduced, and the color tone of the molded product tends to be improved.

The fluorine atom content is preferably 1 ppm or more, and more preferably 10 ppm or more. If the fluorine atom content is in the foregoing range, the reactivity derived from the aromatic ring in the repeating units of the PAEK resin tends to decrease, and the ratio of forming a branched structure during thermoforming tends to decrease.

The fluorine atom content can be measured by the method described in the EXAMPLES section below.

The chlorine atom content per 100 mass % of the PAEK resin according to this embodiment is preferably 1500 mass ppm or less, more preferably 1000 ppm or less, further preferably 500 ppm or less, particularly preferably 100 ppm or less, and most preferably 10 ppm or less. If the chlorine atom content is in the foregoing range, outgassing due to volatilization of residual components during high-temperature heating tends to be reduced, and the color tone of the molded product tends to be improved.

The chlorine atom content can be measured by the method described in the EXAMPLES section below.

### Production Method for Polyarylene Ether Ketone Resin (PAEK Resin)

As a production method for a PAEK resin according to this embodiment, for example, a method (hereafter also referred to as production method (I)) by which a monomer component containing a monomer having a phthaloyl skeleton is reacted with a Lewis acid or a Broensted acid anhydride catalyst in a solvent at 10° C. or more for 1 hour or more and then diphenyl ether (3-1) represented by the following general formula (3-1) is added to and reacted with the reaction product is preferable, without being limited thereto.

A monomer whose electrophilicity is improved by a Lewis acid or a Broensted acid anhydride catalyst has low solubility in a solvent depending on its type. With the conventional synthesis methods as described in PTL 1 and PTL 2, monomers that become nucleophiles react successively while the electrophilicity of monomers is improved. As a result, the overall reaction proceeds nonuniformly, and the molecular weight distribution widens when attempting to synthesize a PAEK resin having a high number average molecular weight Mn. With the production method (I), on the other hand, first, the Lewis acid or Broensted acid anhydride catalyst and the monomer component are reacted at 10° C. or more for 1 hour or more to thus improve the electrophilicity of the entire monomer species in the reactor, and then diphenyl ether (3-1) as a nucleophile is added to it. That is, by reacting the Lewis acid or Broensted acid anhydride catalyst and the monomer component in a state of not containing the diphenyl ether (3-1) to improve the electrophilicity, the reaction speed can be made uniform and a PAEK resin having a high molecular weight and a narrow molecular weight distribution can be produced.

For example, the synthesis method using a nucleophilic substitution reaction as described in PTL 7 is known to polymerize two or more types of nucleophilic substitution reaction-active monomers using a solvent such as diphenylsulfone which is at the melting point or less at room temperature and atmospheric pressure while adding alkali metal carbonate and gradually heating to the melting point of the solvent or higher. However, even when heating is performed to initiate the polymerization reaction, the solvent is at the melting point or less at room temperature and atmospheric pressure, so that the nucleophilic substitution reaction-active monomers do not exhibit such reactivity that is exhibited in a typical solution reaction until the temperature reaches the melting point of the solvent or hither, and the nucleophilic substitution reaction-active monomers dissolve and start the polymerization reaction only after the temperature reaches the melting point of the solvent or hither. Hence, immediately after the solvent melts, the monomer concentration is high. Moreover, since the heating has been performed to the melting point of the solvent or higher, the polymerization reaction proceeds immediately, causing disordered formation of an oligomer, a low molecular weight polymerization product, or a polymer with a higher degree of polymerization. In carrying out such a synthesis method by a nucleophilic substitution reaction, another known method involves adding diphenylsulfone and the like together with alkali metal carbonate to first monomers containing one type of nucleophilic substitution reaction-active monomer (for example, a monomer having protonic functional groups such as hydroxyl groups as a plurality of reactive functional groups), heating and stirring to a temperature not less than the melting point of diphenylsulfone in advance, and then further adding second monomers (for example, a monomer having halogen groups such as chloro groups and fluoro groups or pseudohalogen groups such as triflate as a plurality of reactive functional groups) containing one or more types of nucleophilic substitution reaction-active monomers that are reactively paired with the first monomers or further adding the first monomers as a solid in a plurality of batches. In this case, the first monomers and the second monomers or the first monomers added first and the first monomers added later react to form a new covalent bond, resulting in a polymer with a high molecular weight as a polymerization reaction. In the case of the addition in a plurality of batches as a solid as mentioned above, however, not only the foregoing reaction that further increases the molecular weight occurs, but also the reaction between the newly added monomers generates a low molecular weight component. As a result, the low molecular weight component remains in the high molecular weight component. Moreover, during these nucleophilic substitution reactions, the end groups of polymer chains may react within the same molecular chain to give macrocyclic molecules. The reactions proceed to give these polymerization products simultaneously. Furthermore, it is commonly recognized that there is a relationship between the molecular weight of a solute molecule and the solubility in a solvent. In detail, in the case of dissolving high molecular weight substances similar in molecular skeleton in a solvent that dissolves monomer units, molecules with higher molecular weights tend to be less soluble. This is because a high molecular weight substance has a smaller specific surface area to the volume of the molecule than a low molecular weight substance and is less likely to be solvated by solvent molecules. Since a high molecular weight substance is less likely to be solvated, it is more likely to precipitate in the reaction system. Thus, the molecular weight distribution tends to widen. In addition, in the foregoing reaction using the first monomers and the second monomers, the same number of moles of alkali metal halide (or pseudohalide) as the number of moles of the covalent bond formed by the first monomers and the second monomers form. Alkali metal carbonate reacts with the first and second monomers and as a result quickly releases carbon dioxide and is consumed, and the concentration in the reaction solution decreases. Meanwhile, the concentration of alkali metal halide (or pseudohalide) in the reaction solution increases as the polymerization reaction proceeds. When the reaction proceeds to a certain extent, the high molecular weight substance that is less likely to be solvated for the above reason is more likely to precipitate as the solvent reaches a supersaturated state, so that the molecular weight distribution tends to widen. When precipitating from the reaction system as mentioned above, the high molecular weight component includes the low molecular weight component or contains the low molecular weight component as a cocrystal, which is unsuitable for the purpose of producing a PAEK resin having a narrow molecular weight distribution and a low content of low molecular weight components. Although the dilution effect by increasing the amount of solvent can be considered as a typical method for suppressing such precipitation, it is unsuitable for achieving the purpose of obtaining a high molecular weight substance due to the decrease in reaction efficiency, and the end groups of polymer chains may react within the same molecular chain to give macrocyclic molecules. Moreover, although simultaneously increasing the reaction time to improve the reaction efficiency can be considered as a typical method, it increases the chance of the end groups of polymer chains reacting within the same molecular chain to give macrocyclic molecules, and thus is unsuitable for the purpose of producing a PAEK resin having a high molecular weight, a narrow molecular weight distribution, and a low content of low molecular weight components.

In this embodiment, the foregoing monomer component containing a monomer having a phthaloyl skeleton is preferably a monomer component that contains a monomer (1-2) having a terephthaloyl skeleton represented by the following general formula (1-2) and optionally further contains a monomer (2-2) having an isophthaloyl skeleton represented by the following general formula (2-2).

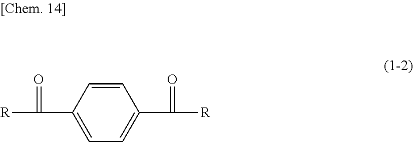

where R may be the same or different, and are each a halogen atom (fluorine atom, chlorine atom, etc.) or a hydroxy group.

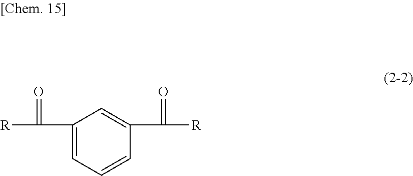

where R may be the same or different, and are each a halogen atom (fluorine atom, chlorine atom, etc.) or a hydroxy group.

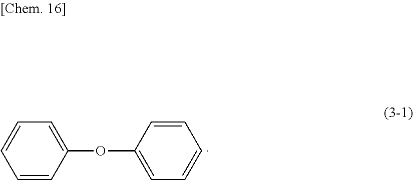 [SMILES: c1ccc(Oc2ccccc2)cc1]

As another example, a method (hereafter also referred to as production method (II)) by which a monomer component containing the monomer (1-2) having a terephthaloyl skeleton represented by the foregoing general formula (1-2) and the diphenyl ether (3-1) represented by the foregoing general formula (3-1) and optionally further containing the monomer (2-2) having an isophthaloyl skeleton represented by the foregoing general formula (2-2) is reacted with a Lewis acid or a Broensted acid anhydride catalyst in a large amount of solvent may be used. The use of a large amount of solvent can improve the solubility of the monomer component and improve the reactivity. A PAEK resin having a narrow molecular weight distribution can thus be obtained.

The PAEK resin according to the present disclosure has the feature of having a high molecular weight and a narrow molecular weight distribution. To achieve this, selecting an appropriate reaction time and selecting a monomer having high solubility in a solvent are also effective besides the production method (I) and the production method (II).

The production method (I) and the production method (II) for the PAEK resin according to this embodiment are preferably Friedel-Crafts reaction type aromatic electrophilic substitution polycondensation reactions in a solution. Such aromatic electrophilic substitution polycondensation reactions can be made under milder polymerization conditions than other polymerization conditions.

The reaction temperature between the monomer component and the Lewis acid or Broensted acid anhydride catalyst in the production method (I) is preferably 10° C. to 40° C., and more preferably 15° C. to 40° C.

The reaction temperature after the addition of the diphenyl ether (3-1) in the production method (I) and the reaction temperature in the production method (II) are preferably 30° C. to 100° C., more preferably 40° C. to 90° C., and further preferably 40° C. to 80° C. As a result of the reaction temperature being 30° C. or more, the solubility of the obtained polymer is less likely to decrease, the precipitation is less likely to occur, and the reaction is less likely to stop halfway. Hence, the reaction proceeds uniformly, and a PAEK resin having a narrow molecular weight distribution can be obtained. As a result of the reaction temperature being 100° C. or less, an excessive increase in the molecular weight can be prevented. Moreover, an excessive branching reaction involving gel generation and the like can be suppressed.

The reaction time between the monomer component and the Lewis acid or Broensted acid anhydride catalyst in the production method (I) is preferably 1 hour to 6 hours, and more preferably 1 hour to 4 hours. As a result of the reaction time being in the foregoing range, a solution with improved electrophilicity can be produced by the reaction between the monomer component and the Lewis acid or Broensted acid anhydride catalyst, and the reaction speed with the diphenyl ether (3-1) as nucleophile can be made uniform. A PAEK resin having a high molecular weight and a narrow molecular weight distribution can thus be produced.

The reaction time after the addition of the diphenyl ether (3-1) in the production method (I) and the reaction time in the production method (II) are preferably 0.5 hours to 100 hours, more preferably 0.5 hours to 50 hours, and further preferably 1 hour to 50 hours. As a result of the reaction time being in the foregoing range, polymerization can be carried out while the reaction solution remains uniform. A PAEK resin having a high molecular weight and a narrow molecular weight distribution can thus be obtained.

The Lewis acid is defined as a concept that encompasses its complex. Examples thereof include Lewis acid catalysts, e.g. metal halides such as boron trifluoride, boron trichloride, boron tribromide, aluminum chloride, aluminum bromide, titanium tetrachloride, ferric chloride, tin tetrachloride, and antimony pentachloride, metal halide complexes such as boron trifluoride ether complex, and metal halide complexes having organic groups.

Examples of the Broensted acid anhydride catalyst include trifluoromethanesulfonic anhydride, nonafluorobutanesulfonic anhydride, heptadecafluorooctane sulfonic anhydride, benzenesulfonic anhydride, p-toluenesulfonic anhydride, monofluoroacetic anhydride, difluoroacetic anhydride, trifluoroacetic anhydride, trichloroacetic anhydride, chlorodifluoroacetic anhydride, pentafluoropropionic anhydride, and heptafluorobutyric anhydride

These Lewis acids or Broensted acid anhydride catalysts may be used singly or in combination of two or more.

Examples of preferable solvents for the polymerization reaction include tetrachloroethylene, 1,2,4-trichlorobenzene, o-difluorobenzene, 2-dichloroethanedichlorobenzene, 1,1,2,2,2-tetrachloroethane, o-dichlorobenzene, dichloromethane, tetrachloromethane, chloroform, 1,2-dichloroethane, cyclohexane, carbon disulfide, nitromethane, nitrobenzene, and HF. Moreover, organic sulfonic acids may be used, and examples thereof include trifluoromethanesulfonic acid, nonafluorobutanesulfonic acid, heptadecafluorooctane sulfonic acid, benzenesulfonic acid, and p-toluenesulfonic acid.

The ratio of the addition amount of the organic sulfonic acid in the solvent and the addition amount of the Broensted acid anhydride catalyst, expressed as [organic sulfonic acid]:[Broensted acid anhydride catalyst], is preferably in the range of 100:95 to 100:5 and more preferably in the range of 100:90 to 100:10 in molar ratio.

The ratio of the total addition amount of the organic sulfonic acid in the solvent and the Broensted acid anhydride catalyst and the total addition amount of the monomer (1-2), the monomer (2-2), and the diphenyl ether (3-1), expressed as [total of organic sulfonic acid and Broensted acid anhydride catalyst]:[total of monomer (1-2), monomer (2-2), and diphenyl ether (3-1)], is preferably in the range of 100:95 to 100:1 and more preferably in the range of 100:90 to 100:2 in molar ratio.

In the production method (I), an oligomer component may be added in addition to the foregoing monomer component. As the oligomer component, an oligomer containing a repeating unit represented by general formula (1-1) or a repeating unit represented by general formula (1-2) is preferable, and an oligomer represented by the following general formula (8-1), an oligomer represented by the following general formula (8-2), an oligomer represented by the following general formula (8-3), or an oligomer represented by the following general formula (8-4) is more preferable. These oligomer components may be used singly or in combination of two or more.

In the production method (I), for example, production can be achieved by a reaction of the monomer (1-2), the diphenyl ether (3-1), and the oligomer represented by the following general formula (8-1) and/or the oligomer represented by the following general formula (8-2) in the presence of the foregoing organic sulfonic acid and Broensted acid anhydride catalyst.

Alternatively, production can be achieved by a reaction of the monomer (1-2), the diphenyl ether (3-1), and the oligomer represented by the following general formula (8-3) and/or the oligomer represented by the following general formula (8-4) in the presence of the foregoing organic sulfonic acid and Broensted acid anhydride catalyst.

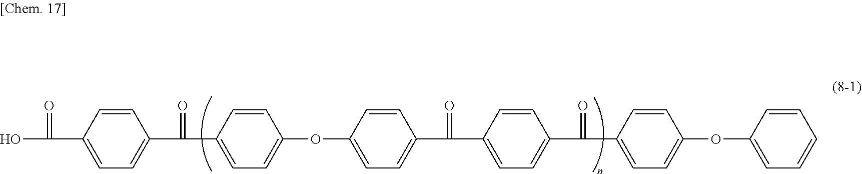

where n is an integer of 0 to 5.

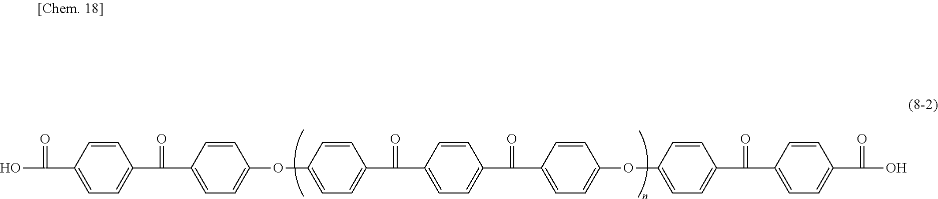

where n is an integer of 0 to 5.

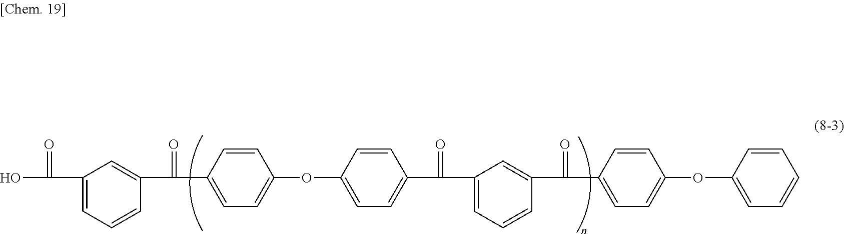

where n is an integer of 0 to 5.

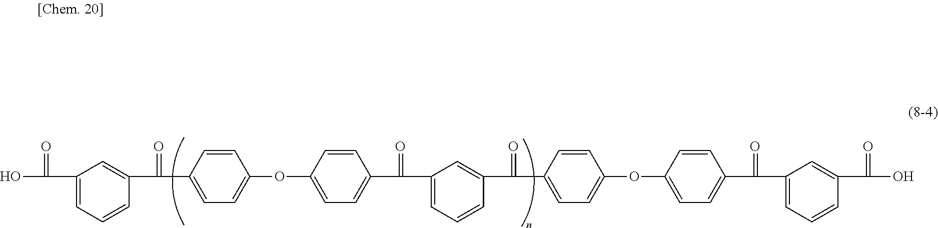

where n is an integer of 0 to 5.

The production method using an oligomer component is also preferably a Friedel-Crafts reaction type aromatic electrophilic substitution polycondensation reaction in a solution. Such an aromatic electrophilic substitution polycondensation reaction can be made under relatively mild polymerization conditions.

The PAEK resin according to this embodiment having a narrow molecular weight distribution has an improved color tone as compared with a PAEK resin having a wide molecular weight distribution synthesized by a conventional method, and has high versatility when molded.

The tensile breaking strength of the PAEK resin according to this embodiment is preferably 110 MPa to 145 MPa, more preferably 115 MPa to 140 MPa, and further preferably 120 MPa to 135 MPa. If the tensile breaking strength is in the foregoing range, a molded product with high strength can be obtained.

The tensile breaking strength is a value measured at 23° C. in accordance with ISO 527-1 and ISO 527-2, and specifically can be measured by the method described in the EXAMPLES section below.

The Charpy impact strength of the PAEK resin according to this embodiment is preferably 5 kJ/m² or more, more preferably 6 kJ/m² or more, and further preferably 7 kJ/m² or more. If the Charpy impact strength is in the foregoing range, a molded product with high impact resistance can be obtained.

The Charpy impact strength is a value measured at 23° C. in accordance with ISO179-1 and ISO179-2, and specifically can be measured by the method described in the EXAMPLES section below.

The thermal weight loss rate of the PAEK resin according to this embodiment, which is an index of the outgassing amount, is preferably 1.5% or less, more preferably 1.3% or less, and further preferably 1.1% or less. If the thermal weight loss rate is in the foregoing range, a molded product with a good appearance can be obtained with little outgassing.

The thermal weight loss rate is a value measured using a thermogravimetric apparatus (TGA), and specifically can be measured by the method described in the EXAMPLES section below.

### Composition Containing Polyarylene Ether Ketone Resin (PAEK Resin)

A composition according to this embodiment contains the above-described PAEK resin according to this embodiment.

The mass ratio of the PAEK resin according to this embodiment per 100 mass % of the composition according to this embodiment is preferably 50 mass % or more, more preferably 70 mass % or more, further preferably 80 mass % or more, and particularly preferably 90 mass % or more.

The composition according to this embodiment may further contain additives. Examples of the additives include 2,4,8,10-tetra(tert-butyl)-6-hydroxy-12H-dibenzo[d,g][1,3,2]dioxaphosphocin 6-oxide sodium salt (CAS No.: 85209-91-2) and tetrakis(2,4-di-tert-butylphenyl)[1,1′-biphenyl]-4,4′-diylbisphosphonite (119345-01-6), without being limited thereto.

The mass ratio of the additives per 100 mass % of the composition according to this embodiment is preferably 30 mass % or less, more preferably 20 mass % or less, and further preferably 10 mass % or less.

### Molded Product Containing Polyarylene Ether Ketone Resin (PAEK Resin)

The PAEK resin according to this embodiment has a high molecular weight and a narrow molecular weight distribution, and therefore has excellent mechanical properties when molded. The PAEK resin according to this embodiment also has excellent heat resistance, a high glass transition temperature (Tg), a melting point (Tm) adjustable while retaining high crystallinity, and good molding processability.

In addition to use as neat resin, the PAEK resin according to this embodiment can be used as a composite material through compounding with glass fibers, carbon fibers, cellulose fibers, a fluororesin, or the like.

The PAEK resin according to this embodiment can be molded into primary products such as pellets, films, rods, boards, filaments, and fibers, and secondary products such as gears, composites, implants, filters, 3D-printed molded products, and parts for automobiles and aircraft via various injection molded or machined products. The PAEK resin according to this embodiment is also usable in electrical and electronic materials, and in medical components for which health and safety considerations are highly required.

### EXAMPLES

The presently disclosed techniques will be described in more detail below by way of the following examples, although the scope of the present disclosure is not limited to these examples.

### Example A and Comparative Example A

The evaluation methods used in Examples A1 to A11 and Comparative Examples 1l to A8 are as follows.

### Evaluation

### [Measurement of Number Average Molecular Weight Mn and Molecular Weight Distribution Mw/Mn]

The number average molecular weight Mn, the weight average molecular weight Mw, and the molecular weight distribution Mw/Mn were measured for each of the PAEK resins obtained in Example A and Comparative Example A using a GPC system (HPLC8320) manufactured by Tosoh Corporation, HLC-83220 GPC EcoSEC System Control Version 1.14 as instrument control software, an RI detector equipped by standard with the system as the detector, and hexafluoroisopropanol containing 0.4 mass % of sodium trifluoroacetate dissolved in an eluent. Shodex KF-606M was used as the column. Methyl polymethacrylate (PMMA) was used as the standard material. The measurement results were analyzed using HLC-83220 GPC EcoSEC Data Analysis Version 1.15. The baseline was drawn from the rise to fall of a chromatographic peak, and the number average molecular weight (Mn), the weight average molecular weight (Mw), and the molecular weight distribution (Mw/Mn) were calculated from the obtained peaks through conversions based on a PMMA calibration curve (EasiVial by Agilent Technologies, Inc.) of the standard material.

### [Glass Transition Temperature (Tg), Crystal Melting Point (Tm), Crystallization Temperature (Tc), and Crystal Melting Enthalpy Change (ΔH)]

Measurement was carried out on each of the PAEK resins obtained in Example A and Comparative Example A using a DSC apparatus (DSC3500) manufactured by NETZSCH. 5 mg of a sample which had not been subjected to any special heat treatment after polymerization was collected in an aluminum pan, and measured using a conditional program of increasing from 50° C. to 400° C. under a temperature increase condition of 20° C./min and decreasing from 400° C. to 50° C. under a temperature decrease condition of 10° C./min in a nitrogen gas stream of 20 mL/min. Unless otherwise stated, the glass transition temperature (Tg), the crystal melting point (Tm), and the crystallization temperature (Tc) were determined as the temperatures of the midpoint of the glass transition point, the peak top of the melting point peak, and the peak top of the crystallization temperature peak respectively, detected in the second program cycle after the measurement start under the foregoing temperature increase condition. Moreover, the crystal melting enthalpy change (ΔH) (J/g) detected in the second program cycle was obtained.

### [Quantification of Repeating Units and Numbers of Ketone Groups and Ether Groups in PAEK Resin by NMR]

Each of the PAEK resins obtained in Example A and Comparative Example A was dissolved in HFIP-d₂, and measurement was carried out using an NMR system (ECZ-500) manufactured by JEOL Ltd. with ¹³C as the observation nucleus, a waiting time of 5 seconds, a measurement temperature of 25° C., and a total number of integrations of 250,000 times. The respective ratios (mol %) of the repeating units (1-1) and (2-1) in the polymer were calculated.

Moreover, the number of ketone groups (mol %) and the number of ether groups (mol %) in the repeating units in the polymer were calculated from the sum of the integral values derived from the ketone group carbon and half the sum of the integral values derived from the ether group ipso carbon, respectively, with respect to the sum of the integral values derived from the repeating unit carbon. The chemical shift of HFIP-d₂ (68.95 ppm) was used as the standard to identify chemical shifts, and the signals derived from the ketone group carbon and the signals derived from the ether group ipso aromatic ring carbon were each separately confirmed to be signals derived from the quaternary carbon that disappeared at dept 135°. For each quantification, calculation was made based on the signals observed at 195 ppm to 205 ppm and 155 ppm to 165 ppm.

### [Tensile Test]

Each of the PAEK resins obtained in Example A and Comparative Example A was dried with hot air at 150° C. for 3 hours, and then a 1A type test piece (4 mm thick) according to ISO 527-2 was molded using an injection molding machine. The cylinder temperature was Tm+20° C., and the mold temperature was 250° C. (in Examples A5 and A6, Tg−30° C.).

For the obtained ISO tensile test piece (4 mm thick), a tensile test was performed under the conditions of 23° C., a chuck interval of 50 mm, and a tensile speed of 5 mm/min using an Instron type tensile tester in accordance with ISO 527-1 and ISO 527-2, and the stress at the upper yield point (yield strength) (unit: MPa) was measured.

### [Charpy Impact Strength]

For the ISO tensile test piece obtained by the method described in [Tensile test] above, the notched Charpy impact strength (unit: kJ/m²) was measured at a temperature of 23° C. in accordance with ISO179-1 and ISO179-2.

A Charpy impact strength of 7 kJ/m² or more was evaluated as “⊚ (excellent)”, a Charpy impact strength of 5 kJ/m² or more and less than 7 kJ/m² as “O (satisfactory)”, a Charpy impact strength of more than 4 kJ/m² and less than 5 kJ/m² as “Δ (unsatisfactory)”, and a Charpy impact strength of 4 kJ/m² or less as “X (poor)”.

### [Thermal Weight Loss Rate]

For each of the PAEK resins obtained in Example A and Comparative Example A, the thermal weight loss rate (%) when the temperature was increased from room temperature to 500° C. at 20° C./min in a nitrogen gas stream of 20 mL/min and held at 500° C. for 1 hour was measured using TGA (TGA device (TG-DTA2500 Regulus) manufactured by NETZSCH Japan K.K.), and used as an index of the outgassing amount. The outgassing amount is determined to be greater when the thermal weight loss rate is higher.

### [Molding Processability]

For the ISO tensile test piece obtained by the method described in [Tensile test] above, the ratio of high molecular weight components was determined by the following method to evaluate the molding processability. The molding processability was evaluated as “O (good)” in the case where the ratio of high molecular weight components was less than 7.0%, and evaluated as “X (poor)” in the case where the ratio of high molecular weight components was 7.0% or more.

### Ratio of High Molecular Weight Components

In the graph of the differential molecular weight distribution in the case of measuring GPC using a GPC system (HPLC8320) manufactured by Tosoh Corporation with a sampling pitch of 100 msec, the ratio (%) of the area of the part with log M (where M is the molecular weight) of 4.8 or more in the horizontal axis to the area of the entire graph was determined and taken to be the ratio of high molecular weight components. When the ratio of the high molecular weight region is not less than a certain ratio, the viscosity during molding increases and the molding processability degrades.

The ratio of high molecular weight components was calculated as follows: The differential molecular weight distribution results of chromatogram obtained by analysis using HLC-83220 GPC EcoSEC Data Analysis Version 1.15 with the method described in [Measurement of number average molecular weight Mn and molecular weight distribution Mw/Mn] above were written out as a CSV file. Using Microsoft 365 Apps for enterprise Excel, the minute area value between the data points for each sampling pitch regarding peaks was calculated, and the sum thereof was taken to be the area of the entire graph. For the part with log M of 4.8 or more, the sum of the minute area values was equally calculated, and then the ratio was calculated.

### [Ratio of Low Molecular Weight Components]

In the graph of the differential molecular weight distribution in the case of measuring GPC using a GPC system (HPLC8320) manufactured by Tosoh Corporation with a sampling pitch of 100 msec, the ratio (%) of the area of the part with log M (where M is the molecular weight) of 3.4 or less in the horizontal axis to the area of the entire graph was determined and taken to be the ratio (%) of low molecular weight components. When the ratio of the low molecular weight region is not less than a certain ratio, outgassing occurs due to volatilization of low molecular weight components during high-temperature heating. This causes poor appearance, such as color tone changes in the resin or molded product or air bubbles or cracks in the molded product.

The ratio of low molecular weight components was calculated as follows: The differential molecular weight distribution results of chromatogram obtained by analysis using HLC-83220 GPC EcoSEC Data Analysis Version 1.15 with the method described in [Measurement of number average molecular weight Mn and molecular weight distribution Mw/Mn] above were written out as a CSV file. Using Microsoft 365 Apps for enterprise Excel, the minute area value between the data points for each sampling pitch regarding peaks was calculated, and the sum thereof was taken to be the area of the entire graph. For the part with log M of 3.4 or less, the sum of the minute area values was equally calculated, and then the ratio was calculated.

### [Fluorine Atom Content]

The fluorine atom content (mass ppm) in each of the PAEK resins obtained in Example A and Comparative Example A was determined. Ion chromatograph (ICS-1500) by Nippon Dionex K.K. was used for analysis of fluorine element.

### [Al Atom Content]

About 0.1 g of a sample of each of the PAEK resins obtained in Example A and Comparative Example A was precisely weighed out in a decomposition vessel made of tetrafluoromethoxyl (TFM), and pressurized acid decomposition was performed by adding 1 mL of sulfuric acid and 1 mL of nitric acid in a microwave decomposition apparatus. The resultant decomposed solution was adjusted to a volume to 50 mL, and measured by an ICP-MS apparatus manufactured by Thermo Fisher Scientific, Inc. to determine the Al atom content (mass ppm) in the PAEK resin.

### [Chlorine Atom Content]

The chlorine atom content (mass ppm) in each of the PAEK resins obtained in Example A and Comparative Example A was determined. Ion chromatograph (ICS-1500) by Nippon Dionex K.K. was used for analysis of chlorine element.

### Example A1

56 g of terephthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The mixture was then heated to 90° C., and stirred for 1 hour (second reaction). The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8200 and Mw/Mn was 2.1, and it was confirmed that the PAEK resin (PEKK polymer) of Example A1 was obtained.

The obtained PEKK polymer was analyzed in the above-described manner. The synthesis parameters and analysis results are shown in Table 1.

### Example A2

49 g of terephthaloyl chloride, 6 g of isophthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8500 and Mw/Mn was 2.2, and it was confirmed that the PAEK resin (PEKK polymer) of Example A2 was obtained.

The obtained PEKK polymer was analyzed in the above-described manner. The synthesis parameters and analysis results are shown in Table 1.

### Example A3

45 g of terephthaloyl chloride, 11 g of isophthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 9300 and Mw/Mn was 2.0, and it was confirmed that the PAEK resin (PEKK polymer) of Example A3 was obtained.

The obtained PEKK polymer was analyzed in the above-described manner. The synthesis parameters and analysis results are shown in Table 1.

### Example A4

39 g of terephthaloyl chloride, 17 g of isophthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8700 and Mw/Mn was 1.8, and it was confirmed that the PAEK resin (PEKK polymer) of Example A4 was obtained.

The obtained PEKK polymer was analyzed in the above-described manner. The synthesis parameters and analysis results are shown in Table 1.

### Example A5

34 g of terephthaloyl chloride, 22 g of isophthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 9100 and Mw/Mn was 1.9, and it was confirmed that the PAEK resin (PEKK polymer) of Example A5 was obtained.

The obtained PEKK polymer was analyzed in the above-described manner. The synthesis parameters and analysis results are shown in Table 1.

### Example A6

28 g of terephthaloyl chloride, 28 g of isophthaloyl chloride, 81 g of aluminum chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8800 and Mw/Mn was 2.4, and it was confirmed that the PAEK resin (PEKK polymer) of Example A6 was obtained.

The obtained PEKK polymer was analyzed in the above-described manner. The synthesis parameters and analysis results are shown in Table 1.

### Example A7

39 g of terephthaloyl chloride, 17 g of isophthaloyl chloride, 101 g of iron (III) chloride, and 1600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8200 and Mw/Mn was 2.1, and it was confirmed that the PAEK resin (PEKK polymer) of Example A7 was obtained.

The obtained PEKK polymer was analyzed in the above-described manner. The synthesis parameters and analysis results are shown in Table 1.

### Example A8

39 g of terephthaloyl chloride, 17 g of isophthaloyl chloride, 81 g of aluminum chloride, and 1,600 g of 1,2-dichloroethane were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 8200 and Mw/Mn was 2.4, and it was confirmed that the PAEK resin (PEKK polymer) of Example A8 was obtained.

The obtained PEKK polymer was analyzed in the above-described manner. The synthesis parameters and analysis results are shown in Table 1.

### Example A9

39 g of terephthaloyl chloride, 17 g of isophthaloyl chloride, 81 g of aluminum chloride, and 1,600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The mixture was then heated to 90° C., and stirred for 2 hours (second reaction). The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 12300 and Mw/Mn was 1.8, and it was confirmed that the PAEK resin (PEKK polymer) of Example A9 was obtained.

The obtained PEKK polymer was analyzed in the above-described manner. The synthesis parameters and analysis results are shown in Table 1.

### Example A10

39 g of terephthaloyl chloride, 17 g of isophthaloyl chloride, 81 g of aluminum chloride, and 1,600 g of o-dichlorobenzene were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 47 g of diphenyl ether was added while maintaining the temperature below 5° C. The mixture was then heated to 90° C., and stirred for 3 hours (second reaction). The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 14500 and Mw/Mn was 1.9, and it was confirmed that the PAEK resin (PEKK polymer) of Example A10 was obtained.

The obtained PEKK polymer was analyzed in the above-described manner. The synthesis parameters and analysis results are shown in Table 1.

### Example A11

35 g of terephthalic acid, 15 g of isophthalic acid, 170 g of trifluoromethanesulfonic acid, and 158 g of trifluoroacetic anhydride were charged into a four-necked separable flask equipped with a nitrogen inlet tube, a thermometer, a reflux cooling tube, and a stirrer, and stirred at 25° C. for 2 hours in a nitrogen atmosphere (first reaction). The mixture was cooled to −5° C., and then 51 g of diphenyl ether was added while maintaining the temperature below 5° C. The mixture was then heated to 70° C., and stirred for 6 hours (second reaction). After cooling to room temperature, the reaction solution was poured into a vigorously stirred 1N sodium hydroxide aqueous solution to precipitate a polymer, followed by filtration. The filtered polymer was washed twice with distilled water and ethanol. The polymer was then dried under vacuum at 150° C. for 8 hours. When the molecular weight and the molecular weight distribution were measured using GPC, Mn was 8000 and Mw/Mn was 1.9, and it was confirmed that the PAEK resin (PEKK polymer) of Example A11 was obtained.

The obtained PEKK polymer was analyzed in the above-described manner. The synthesis parameters and analysis results are shown in Table 1.

### Comparative Example A1

### [Polymerization Example Using Diphosphorus Pentoxide]

950 g of trifluoromethanesulfonic acid, 35 g of terephthalic acid, and 15 g of isophthalic acid were charged into a four-necked separable flask equipped with a nitrogen inlet tube, a thermometer, a reflux cooling tube, and a stirrer, and stirred at room temperature for 20 hours in a nitrogen atmosphere. The mixture was then charged into a flask in which 51 g of diphenyl ether and 103 g of diphosphorus pentoxide were stirred, and heated to 100° C. and then stirred for 4 hours. After cooling to room temperature, the reaction solution was poured into a vigorously stirred 1N sodium hydroxide aqueous solution to precipitate a polymer, followed by filtration. The filtered polymer was washed twice with distilled water and ethanol. The polymer was then dried under vacuum at 150° C. for 8 hours. When the molecular weight distribution was measured using GPC, Mn was 10,000 and Mw/Mn was 4.1, and it was confirmed that the PAEK resin (PEKK polymer) of Comparative Example A1 was obtained.

The obtained PEKK polymer was analyzed in the above-described manner. The analysis results are shown in Table 2.

### Comparative Example A2

### [Polymerization Example in Which Addition Was Performed Simultaneously]

56 g of terephthalic acid dichloride, 51 g of diphenyl ether, and 163 g of o-dichlorobenzene were charged into a four-necked separable flask equipped with a nitrogen inlet tube, a thermometer, a reflux cooling tube, and a stirrer, 102 g of anhydrous aluminum trichloride was added while maintaining the temperature at 5° C. or less in a nitrogen atmosphere, and the mixture was stirred at 0° C. for 30 minutes. After this, 1000 g of o-dichlorobenzene was added, and the mixture was stirred at 130° C. for 1 hour and then cooled to room temperature. The supernatant was removed by decantation, and the remaining reaction suspension was poured into a vigorously stirred 1N sodium hydroxide aqueous solution to precipitate a polymer, followed by filtration. The filtered polymer was washed twice with distilled water and ethanol. The polymer was then dried under vacuum at 150° C. for 8 hours. When the molecular weight distribution was measured using GPC, Mn was 8,000 and Mw/Mn was 3.5, and it was confirmed that the PAEK resin (PEKK polymer) of Comparative Example A2 was obtained.

The obtained PEKK polymer was analyzed in the above-described manner. The analysis results are shown in Table 2.

### Comparative Example A3

### [Polymerization Example in Which Addition Was Performed Simultaneously]

39 g of terephthalic acid dichloride, 17 g of isophthalic acid, 51 g of diphenyl ether, and 163 g of o-dichlorobenzene were charged into a four-necked separable flask equipped with a nitrogen inlet tube, a thermometer, a reflux cooling tube, and a stirrer, 102 g of anhydrous aluminum trichloride was added while maintaining the temperature at 5° C. or less in a nitrogen atmosphere, and the mixture was stirred at 0° C. for 30 minutes. After this, 1000 g of o-dichlorobenzene was added, and the mixture was stirred at 130° C. for 1 hour and then cooled to room temperature. The supernatant was removed by decantation, and the remaining reaction suspension was poured into a vigorously stirred 1N sodium hydroxide aqueous solution to precipitate a polymer, followed by filtration. The filtered polymer was washed twice with distilled water and ethanol. The polymer was then dried under vacuum at 150° C. for 8 hours. When the molecular weight distribution was measured using GPC, Mn was 8,700 and Mw/Mn was 3.6, and it was confirmed that the PAEK resin (PEKK polymer) of Comparative Example A3 was obtained.

The obtained PEKK polymer was analyzed in the above-described manner. The analysis results are shown in Table 2.

### Comparative Example A4

As the PEKK resin of Comparative Example A4, PEKK polymer manufactured by Goodfellow was analyzed in the above-described manner. The analysis results are shown in Table 2.

### Comparative Example A5

As the PEEK resin of Comparative Example A5, PEEK polymer manufactured by Sigma-Aldrich Co. LLC was analyzed in the above-described manner. The analysis results are shown in Table 2.

### Comparative Example A6

### [Polymerization Example Using Biphenyl Instead of Diphenyl Ether]

39 g of terephthaloyl chloride, 17 g of isophthaloyl chloride, 81 g of aluminum chloride, and 1,600 g of o-dichlorobenzene were charged into a four-necked separable flask equipped with a nitrogen inlet tube, a thermometer, a reflux cooling tube, and a stirrer, and stirred for 2 hours in a nitrogen atmosphere. The mixture was cooled to −5° C., and then 46 g of biphenyl was added while maintaining the temperature below 5° C. The mixture was then heated to 90° C., and stirred for 1 hour. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 11000 and Mw/Mn was 2.5, and it was confirmed that the PAEK resin (PEKK polymer) of Comparative Example A6 was obtained.

The obtained PEKK polymer was analyzed in the above-described manner. The analysis results are shown in Table 2.

### Comparative Example A7

[Polymerization Example Using 1,4-diphenoxybenzene Instead of Diphenyl Ether]

39 g of terephthaloyl chloride, 17 g of isophthaloyl chloride, 81 g of aluminum chloride, and 1,600 g of o-dichlorobenzene were charged into a four-necked separable flask equipped with a nitrogen inlet tube, a thermometer, a reflux cooling tube, and a stirrer, and stirred for 2 hours in a nitrogen atmosphere. The mixture was cooled to −5° C., and then 79 g of 1,4-diphenoxybenzene was added while maintaining the temperature below 5° C. The mixture was then heated to 90° C., and stirred for 1 hour. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 10900 and Mw/Mn was 2.4, and it was confirmed that the PAEK resin (PEKK polymer) of Comparative Example A7 was obtained.

The obtained PEKK polymer was analyzed in the above-described manner. The analysis results are shown in Table 2.

### Comparative Example A8

### [Polymerization Example Intended to Decrease Number Average Molecular Weight Mn]

39 g of terephthaloyl chloride, 17 g of isophthaloyl chloride, 81 g of aluminum chloride, and 1,600 g of o-dichlorobenzene were charged into a four-necked separable flask equipped with a nitrogen inlet tube, a thermometer, a reflux cooling tube, and a stirrer, and stirred for 2 hours in a nitrogen atmosphere. The mixture was cooled to −5° C., and then 47 g of diphenyl ether was added while maintaining the temperature below 5° C. The mixture was then heated to 45° C., and stirred for 1 hour. The polymer was recovered from the suspension by filtration under vacuum. This was then washed on the filter with 300 g of methanol. The polymer was removed from the filter, and reslurried in 700 g of methanol in a beaker with magnetic stirring for 2 hours. The polymer was then subjected to the second filtration, and rinsed the second time with 300 g of methanol. The resultant polymer was removed from the filter, and reslurried in 750 g of acidified water (3% HCl) in a beaker with magnetic stirring for 2 hours. The suspension was filtered, and the resultant solids were filter rinsed with 450 g of water and then reslurried in 400 g of a sodium hydroxide solution (0.5%) for 2 hours. After filtration, water was used to rinse the solids until the pH of the filtrate was neutral. This was then dried overnight in a vacuum oven at 180° C. When the molecular weight and the molecular weight distribution were measured using GPC, Mn was 3800 and Mw/Mn was 2.4, and it was confirmed that the PAEK resin (PEKK polymer) of Comparative Example A8 was obtained.

The obtained PEKK polymer was analyzed in the above-described manner. The analysis results are shown in Table 2.

In Comparative Example A8, in the differential molecular weight distribution graph obtained by GPC measurement, a peak was located in the range of log M less than 4.8, and there was no part with log M of 4.8 or more.

### Comparative Example A9

100 g of terephthalic acid and 103 g of diphenyl ether were charged into a four-necked separable flask equipped with a nitrogen inlet tube, a thermometer, a reflux cooling tube, and a stirrer, 1000 g of trifluoromethanesulfonic anhydride was added in a nitrogen atmosphere, and the mixture was stirred at 60° C. for 30 minutes. After this, 192.3 g of trifluoromethanesulfonic acid was added, and the mixture was stirred for 6 hours while maintaining the temperature. After cooling to room temperature, the reaction solution was poured into a vigorously stirred 1N sodium hydroxide aqueous solution to precipitate a polymer, followed by filtration. The filtered polymer was washed twice with distilled water and ethanol. The polymer was then dried under vacuum at 150° C. for 8 hours. When the molecular weight and molecular weight distribution were measured using GPC, the differential molecular weight distribution showed a curve giving bimodal peaks separated by a baseline. When these peaks were analyzed as independent peaks, Mn was 5100 and 492 and Mw/Mn was 1.1 and 1.2, and it was confirmed that the PAEK resin of Comparative Example A9 was obtained.

The obtained PEKK polymer was analyzed in the above-described manner. The analysis results are shown in Table 2.

### Comparative Example A10

102 g of diphenylsulfone, 18.5 g of 1,3-bis(4′-hydroxybenzoyl)benzene, 6.36 g of Na₂CO₃, and 0.040 g of K₂CO₃ were added to a four-necked reaction flask. The flask was equipped with a stirrer, a N₂ inlet, a Clausen adapter with a thermocouple in a reaction medium, and a Dean-Stark trap with a reflux condenser and dry ice trap. The contents of the flask were evacuated under vacuum, and then filled with high purity nitrogen (O₂: less than 10 ppm). The reaction mixture was then placed under a constant nitrogen purge (60 mL/min).

The reaction mixture was slowly heated from room temperature to 180° C. At 180° C., 18.9 g of 1,4-bis(4′-fluorobenzoyl)benzene was added to the reaction mixture via a powder dispenser over 30 minutes. At the end of the addition, the reaction mixture was heated to 220° C. at 1° C./min.

At 220° C., a mixture of 13.7 g of 1,4-bis(4′-fluorobenzoyl)benzene, 13.4 g of 1,4-bis(4′-hydroxybenzoyl)benzene, 4.61 g of Na₂CO₃, and 0.029 g of K₂CO₃ was slowly added to the reaction mixture over 30 minutes.

At the end of the addition, the reaction mixture was heated to 320° C. at 1° C./min. After holding at 320° C. for 5 minutes, 1.29 g of 1,4-bis(4′-fluorobenzoyl)benzene was added to the reaction mixture while maintaining a nitrogen purge on the flask. After 5 minutes, 0.427 g of lithium chloride was added to the reaction mixture. After 10 minutes, 0.323 g of 1,4-bis(4′-fluorobenzoyl)benzene was added to the reaction flask and the reaction mixture was kept at constant temperature for 15 minutes.

The contents of the flask were then poured into a stainless steel saucer and cooled. The solids were broken up, passed through a 2 mm screen, and ground in an attrition mill. Diphenylsulfone and salts were extracted from the mixture with acetone and water. The powder was then removed from the flask and dried at 160° C. for 12 hours under vacuum. When the molecular weight was measured using GPC, Mn was 9000 and Mw/Mn was 6.3, and it was confirmed that the PAEK resin (PEKK polymer) of Comparative Example A10 was obtained.

The obtained PEKK polymer was analyzed in the above-described manner. The results of the analysis are shown in Table 2.

As shown in Table 1, the PAEK resins of Examples A1 to A11 were able to be adjusted to have a glass transition temperature (Tg) of 130° C. to 170° C. and a crystal melting point (Tm) of 300° C. to 390° C., and were resins excellent in heat resistance substantially equivalent to commercially available PAEK resins (Comparative Examples A4 and A5 in Table 2).

The PAEK resin of Example A was lower in crystal melting point (Tm) than Comparative Example A having the same number average molecular weight Mn and the same ratio of the terephthaloyl skeleton and the isophthaloyl skeleton, and exhibited good molding processability.

The PAEK resins of Examples A1 to A11, as compared with Comparative Examples A1 to A4 and A8 to A10, each had a narrow molecular weight distribution and thus had a low ratio of low molecular weight components, contributing to less outgassing. Moreover, since the ratio of high molecular weight components was low, the molding processability was good.

In particular, the PAEK resins of Examples A1 to A11 improved in tensile strength (upper yield point) and/or Charpy impact strength as compared with Comparative Examples A1 to A4 and A10 having a molecular weight distribution of more than 2.5. These results reflect the fact that the low molecular weight components decreased as a result of the narrowing of the molecular weight distribution.

In addition, the PAEK resins of Examples A1 to A11 were superior in tensile strength (upper yield point) and/or Charpy impact strength to Comparative Examples A6 and A7. In Comparative Example A6, the number of ketone groups in the repeating units was substantially equal to those in Examples A1 to A11 but no ether group was contained, so that the toughness decreased and the resin became brittle. In Comparative Example A7, the tensile strength decreased despite the sum of the number of ketone groups and the number of ether groups in the repeating units being substantially equal to those of Examples A1 to A11.

TABLE 1 TABLE 1

| | | | Example | Example | Example | Example | Example | Example |
|---|---|---|---|---|---|---|---|---|
| | | Unit | A1 | A2 | A3 | A4 | A5 | A6 |
| Composition | Repeating unit | mol % | 100 | 90 | 80 | 70 | 60 | 50 |
| | (1-1) | | | | | | | |
| | Repeating unit | mol % | 0 | 10 | 20 | 30 | 40 | 50 |
| | (2-1) | | | | | | | |
| | Number of ketone groups | mol % | 9.9 | 9.5 | 9.5 | 9.5 | 9.8 | 9.6 |
| | in repeating units | | | | | | | |
| | Number of ether groups | mol % | 5.0 | 4.6 | 4.5 | 4.8 | 4.5 | 4.8 |
| | in repeating units | | | | | | | |
| Reaction | First reaction temperature | ° C. | rt | rt | rt | rt | rt | rt |
| conditions | Second reaction temperature | ° C. | 90 | 90 | 90 | 90 | 90 | 90 |
| | First reaction time | hr | 2 | 2 | 2 | 2 | 2 | 2 |
| | Second reaction time | hr | 1 | 1 | 1 | 1 | 1 | 1 |
| Analysis | Tg | ° C. | 169 | 165 | 158 | 154 | 148 | 168 |
| values | Tm | ° C. | 380 | 360 | 340 | 317 | 301 | — |
| | ΔH | J/g | 54 | 48 | 47 | 43 | 35 | — |
| | Tc | ° C. | 290 | 278 | 255 | 243 | 223 | — |
| | Tm-Tc | ° C. | 90 | 82 | 85 | 74 | 78 | — |
| | Mn | — | 8200 | 8500 | 9300 | 8700 | 9100 | 8800 |
| | Mw/Mn | — | 2.1 | 2.2 | 2.0 | 1.8 | 1.9 | 2.4 |
| | Ratio of low molecular | % | 3.2 | 3.0 | 2.5 | 2.9 | 2.0 | 2.9 |
| | weight components | | | | | | | |
| | Fluorine atom content | mass ppm | 15.0 | 17.0 | 16.0 | 18.0 | 15.0 | 17.0 |
| | Aluminum atom content | mass ppm | 90.0 | 90.0 | 89.0 | 88.0 | 85.0 | 80.0 |
| | Chlorine atom content | mass ppm | 495.0 | 490.0 | 500.0 | 498.0 | 460.0 | 450.0 |
| | Tensile strength | MPa | 145.0 | 139.0 | 133.0 | 125.0 | 119.0 | 110.0 |
| | (upper yield point) | | | | | | | |
| | Charpy impact strength | kJ/m² | 8.0 | 8.0 | 8.0 | 7.5 | 7.0 | 6.5 |
| | | — | ⊚ | ⊚ | ⊚ | ⊚ | ⊚ | ◯ |
| | Thermal weight loss rate | % | 0.7 | 0.9 | 1.1 | 1.2 | 1.3 | 1.4 |
| | Ratio of high molecular | % | 2.1 | 2.9 | 3.2 | 2.0 | 2.1 | 5.2 |
| | weight components | | | | | | | |
| | Molding processability | — | ◯ | ◯ | ◯ | ◯ | ◯ | ◯ |

| | | | Example | Example | Example | Example | Example |
|---|---|---|---|---|---|---|---|
| | | Unit | A7 | A8 | A9 | A10 | A11 |
| Composition | Repeating unit | mol % | 70 | 70 | 70 | 70 | 70 |
| | (1-1) | | | | | | |
| | Repeating unit | mol % | 30 | 30 | 30 | 30 | 30 |
| | (2-1) | | | | | | |
| | Number of ketone groups | mol % | 10.1 | 9.8 | 9.7 | 9.6 | 9.5 |
| | in repeating units | | | | | | |
| | Number of ether groups | mol % | 4.7 | 4.5 | 4.6 | 4.5 | 4.6 |
| | in repeating units | | | | | | |
| Reaction | First reaction temperature | ° C. | rt | rt | rt | rt | rt |
| conditions | Second reaction temperature | ° C. | 90 | 90 | 90 | 90 | 70 |
| | First reaction time | hr | 2 | 2 | 2 | 2 | 2 |
| | Second reaction time | hr | 1 | 1 | 2 | 3 | 6 |
| Analysis | Tg | ° C. | 152 | 159 | 162 | 161 | 155 |
| values | Tm | ° C. | 322 | 327 | 315 | 320 | 330 |
| | ΔH | J/g | 43 | 45 | 46 | 46 | 47 |
| | Tc | ° C. | 241 | 245 | 236 | 234 | 243 |
| | Tm-Tc | ° C. | 81 | 82 | 79 | 86 | 87 |
| | Mn | — | 8200 | 8200 | 12300 | 14500 | 8000 |
| | Mw/Mn | — | 2.1 | 2.4 | 1.8 | 1.9 | 1.9 |
| | Ratio of low molecular | % | 3.2 | 3.4 | 0.8 | 0.1 | 3.0 |
| | weight components | | | | | | |
| | Fluorine atom content | mass ppm | 16.0 | 17.0 | 18.0 | 20.0 | 182.0 |
| | Aluminum atom content | mass ppm | 88.0 | 89.0 | 90.0 | 90.0 | 1.0 |
| | Chlorine atom content | mass ppm | 480.0 | 490.0 | 495.0 | 492.0 | 1.0 |
| | Tensile strength | MPa | 122.0 | 125.0 | 132.0 | 134.0 | 128.0 |
| | (upper yield point) | | | | | | |
| | Charpy impact strength | kJ/m² | 7.0 | 7.0 | 6.5 | 6.5 | 7.0 |
| | | — | ⊚ | ⊚ | ◯ | ◯ | ⊚ |
| | Thermal weight loss rate | % | 1.5 | 1.1 | 1.1 | 1.0 | 1.0 |
| | Ratio of high molecular | % | 2.1 | 3.3 | 5.7 | 6.8 | 1.1 |
| | weight components | | | | | | |
| | Molding processability | — | ◯ | ◯ | ◯ | ◯ | ◯ |

TABLE 2 TABLE 2

| | | | Comparative | Comparative | Comparative | Comparative | Comparative | Comparative |
|---|---|---|---|---|---|---|---|---|
| | | Unit | Example A1 | Example A2 | Example A3 | Example A4 | Example A5 | Example A6 |
| Composition | Repeating unit | mol % | 70 | 100 | 70 | 80 | 70 | 70 |
| | (1-1) | | | | | | | |
| | Repeating unit | mol % | 30 | 0 | 30 | 20 | 30 | 30 |
| | (2-1) | | | | | | | |
| | Number of ketone groups | mol % | 9.9 | 10.0 | 9.9 | 9.9 | 5.0 | 9.5 |
| | in repeating units | | | | | | | |
| | Number of ether groups | mol % | 4.5 | 4.9 | 5.0 | 5.0 | 10.0 | 0.0 |
| | in repeating units | | | | | | | |
| Analysis | Tg | ° C. | 169 | 165 | 162 | 163 | 149 | 169 |
| values | Tm | ° C. | 330 | 402 | 334 | 351 | 342 | 390 |
| | ΔH | J/g | 23 | 28 | 22 | 26 | 22 | 28 |
| | Tc | ° C. | 220 | 295 | 220 | 232 | 230 | 250 |
| | Tm-Tc | ° C. | 110 | 107 | 114 | 119 | 112 | 140 |
| | Mn | — | 10000 | 8000 | 8700 | 9300 | — | 11000 |
| | Mw/Mn | — | 4.1 | 3.5 | 3.6 | 3.8 | — | 2.5 |
| | Ratio of low molecular | % | 5.8 | 6.3 | 5.9 | 5.9 | — | 3.9 |
| | weight components | | | | | | | |
| | Fluorine atom content | mass ppm | 16.0 | 18.0 | 20.0 | 15.0 | 4000.0 | 16.0 |
| | Aluminum atom content | mass ppm | 20.0 | 200.0 | 190.0 | 195.0 | 198.0 | 101.0 |
| | Chlorine atom content | mass ppm | 25.0 | 2000.0 | 2100.0 | 2050.0 | 2050.0 | 600.0 |
| | Tensile strength | MPa | 115.0 | 135.0 | 112.0 | 119.0 | 112.0 | 120.0 |
| | (upper yield point) | | | | | | | |
| | Charpy impact strength | kJ/m² | 4.0 | 4.5 | 4.5 | 4.5 | 4.5 | 4.5 |
| | | — | x | Δ | Δ | Δ | Δ | Δ |
| | Thermal weight loss rate | % | 2.1 | 2.3 | 1.9 | 1.8 | 2.0 | 2.0 |
| | Ratio of high molecular | % | 14.0 | 12.0 | 9.2 | 10.9 | — | 9.2 |
| | weight components | | | | | | | |
| | Molding processability | — | x | x | x | x | — | x |

| | | | Comparative | Comparative | Comparative | Comparative |
|---|---|---|---|---|---|---|
| | | Unit | Example A7 | Example A8 | Example A9 | Example A 10 |
| Composition | Repeating unit | mol % | 70 | 70 | 70 | 70 |
| | (1-1) | | | | | |
| | Repeating unit | mol % | 30 | 30 | 30 | 30 |
| | (2-1) | | | | | |
| | Number of ketone groups | mol % | 7.7 | 9.5 | 9.9 | 9.9 |
| | in repeating units | | | | | |
| | Number of ether groups | mol % | 7.7 | 4.7 | 5.0 | 5.0 |
| | in repeating units | | | | | |
| Analysis | Tg | ° C. | 159 | 157 | 150 | 160 |
| values | Tm | ° C. | 330 | 328 | 330 | 331 |
| | ΔH | J/g | 28 | 20 | 26 | 27 |
| | Tc | ° C. | 220 | 200 | 223 | 222 |
| | Tm-Tc | ° C. | 110 | 128 | 107 | 109 |
| | Mn | — | 10900 | 3800 | 5100 | 9000 |
| | Mw/Mn | — | 2.4 | 2.4 | 1.9 | 6.3 |
| | Ratio of low molecular | % | 3.9 | 19.1 | 10.1 | 6.5 |
| | weight components | | | | | |
| | Fluorine atom content | mass ppm | 50.0 | 14.0 | 332.0 | 3400.0 |
| | Aluminum atom content | mass ppm | 105.0 | 99.0 | 5.0 | 105.0 |
| | Chlorine atom content | mass ppm | 550.0 | 10.0 | 20.0 | 200.0 |
| | Tensile strength | MPa | 117.0 | 98.0 | 101.0 | 114.0 |
| | (upper yield point) | | | | | |
| | Charpy impact strength | kJ/m² | 6.0 | 4.0 | 4.5 | 4.5 |
| | | — | ∘ | x | Δ | Δ |
| | Thermal weight loss rate | % | 2.0 | 9.3 | 4.9 | 2.1 |
| | Ratio of high molecular | % | 9.0 | — | 8.4 | 15.0 |
| | weight components | | | | | |
| | Molding processability | — | x | — | x | x |

### Example B and Comparative Example B

The evaluation methods used in Examples B1 to B4 and Comparative Examples B1 to B5 are as follows.

### Evaluation

### [Measurement of Number Average Molecular Weight Mn and Molecular Weight Distribution Mw/Mn]

For each of the PAEK resins obtained in Example B and Comparative Example B, the number average molecular weight Mn and the molecular weight distribution Mw/Mn were measured by the same method as in Example A and Comparative Example A.

### [Glass Transition Temperature (Tg), Crystal Melting Point (Tm), Crystallization Temperature (Tc), and Crystal Melting Enthalpy Change (ΔH)]

Measurement was carried out on each of the PAEK resins obtained in Example B and Comparative Example B using a DSC apparatus (DSC3500) manufactured by NETZSCH. 5 mg of a sample which had not been subjected to any special heat treatment after polymerization was collected in an aluminum pan, and measured using a conditional program of increasing from 50° C. to 400° C. under a temperature increase condition of 20° C./min and decreasing from 400° C. to 50° C. under a temperature decrease condition of 20° C./min in a nitrogen gas stream of 20 mL/min. The glass transition temperature (Tg), the crystal melting point (Tm), and the crystallization temperature (Tc) were determined as the temperatures of the midpoint of the glass transition point, the peak top of the crystal melting point peak, and the peak top of the crystallization temperature peak respectively, detected in the second program cycle after the measurement start under the foregoing temperature increase condition. Moreover, the crystal melting enthalpy change (ΔH) (J/g) detected in the second program cycle was obtained.

### [Calculation of Temperature Decrease Rate That Maximizes Crystal Melting Enthalpy Change (ΔH)]

For each of the PAEK resins obtained in Example B and Comparative Example B, using a DSC apparatus (DSC3500) manufactured by NETZSCH, 5 mg of a sample which had not been subjected to any special heat treatment after polymerization was collected in an aluminum pan, heating was performed from 50° C. to 400° C. under a temperature increase condition of 20° C./min, and then cooling was performed to 50° C. under a temperature decrease condition of 5° C./min to 25° C./min (2° C./min increments) in a nitrogen gas stream of 20 mL/min. The crystal melting enthalpy change (ΔH) at each temperature decrease condition was calculated, and a temperature decrease rate (° C./min) necessary to maximize the crystal melting enthalpy change (ΔH) was determined.

### [Quantification of Repeating Units in PAEK Resin by NMR]

Each of the PAEK resins obtained in Example B and Comparative Example B was dissolved in HFIP-d₂, and measurement was carried out using an NMR system (ECZ-500) manufactured by JEOL Ltd. with ¹H as the observation nucleus, a waiting time of 5 seconds, a measurement temperature of 25° C., a total number of integrations of 1024 times, and standard 4.4 ppm (HFIP-d₂). The respective ratios (mol %) of the repeating units (1-1) and (2-1) in the polymer were calculated.

### [Quantification of Numbers of Ketone Groups and Ether Groups in PAEK Resin by NMR]

For each of the PAEK resins obtained in Example B and Comparative Example B, the number of ketone groups (mol %) and the number of ether groups (mol %) in the repeating units of the polymer were calculated by the same method as in Example A and Comparative Example A.

### [Tensile Properties]

Each of the PAEK resins obtained in Example B and Comparative Example B was dried with hot air at 150° C. for 3 hours, and then a 1A type test piece (4 mm thick) according to ISO 527-2 was molded using an injection molding machine. The cylinder temperature was Tm+20° C., and the mold temperature was 250° C.

For the obtained ISO tensile test piece (4 mm thick), a tensile test was performed under the conditions of 23° C., a chuck interval of 50 mm, and a tensile speed of 5 mm/min using an Instron type tensile tester in accordance with ISO 527-1 and ISO 527-2, and the stress at the upper yield point (yield strength) (unit: MPa) was measured.

### [Charpy Impact Strength]

The Charpy impact strength (unit: kJ/m²) of each of the PAEK resins obtained in Example B and Comparative Example B was measured and evaluated by the same method as in Example A and Comparative Example A.

### [Chemical Resistance Evaluation Result]

100 mg of each of the PAEK resins obtained in Example B and Comparative Example B was weighed into a lidded glass container, 50 mL of HFIP was added, the lid was closed, and the mixture was shaken for 10 hours while being heated to 40° C. and dissolved completely. The solvent was distilled from the solution using an evaporator, followed by vacuum drying at 160° C. for 5 hours. 10 mg of the dried sample was weighed into a polyethylene lidded glass container, 1 mL of HFIP was added, the lid was closed, and the container was shaken while being heated to 40° C. The chemical resistance (A) of each sample was evaluated based on the time from the start of shaking until the sample was completely dissolved.

Further, for each of the PAEK resins obtained in Example B and Comparative Example B, 15 mg of a sample which had not been subjected to any special heat treatment after polymerization was collected in an aluminum pan, and then a conditional program of increasing from 50° C. to 400° C. under a temperature increase condition of 20° C./min and decreasing from 400° C. to 50° C. under a temperature decrease condition of 20° C./min in a nitrogen gas stream of 20 mL/min was carried out using a DSC apparatus (DSC3500) manufactured by NETZSCH. Here, 10 mg of the molten resin remaining in the aluminum pan was weighed into a lidded glass container, 1 mL of HFIP was added, the lid was closed, and the container was shaken while being heated to 40° C. The chemical resistance (B) of each sample after heat history was evaluated based on the time from the start of shaking until the sample was completely dissolved.

### [Ratio of Low Molecular Weight Components]

The ratio of low molecular weight components (%) of each of the PAEK resins obtained in Example B and Comparative Example B was determined by the same method as in Example A and Comparative Example A.

### [Fluorine Atom Content]

The fluorine atom content (mass ppm) in each of the PAEK resins obtained in Example B and Comparative Example B was measured by the same method as in Example A and Comparative Example A.

[Al Atom Content]

The Al atom content (mass ppm) in each of the PAEK resins obtained in Example B and Comparative Example B was measured by the same method as in Example A and Comparative Example A.

### [Chlorine Atom Content]

The chlorine atom content (mass ppm) in each of the PAEK resins obtained in Example B and Comparative Example B was measured by the same method as in Example A and Comparative Example A.

### Example B1

70 g of terephthalic acid, 30 g of isophthalic acid, 339 g of trifluoromethanesulfonic acid, 315 g of trifluoroacetic anhydride, and 102 g of diphenyl ether were charged in this order into a four-necked separable flask equipped with a nitrogen inlet tube, a thermometer, a reflux cooling tube, and a stirrer, and stirred at 40° C. for 12 hours in a nitrogen atmosphere. After cooling to room temperature, the reaction solution was poured into vigorously stirred distilled water to precipitate a polymer, followed by filtration. The filtered polymer was washed twice with distilled water and ethanol. The polymer was then dried under vacuum at 160° C. for 8 hours.

The measurement and evaluation results are shown in Table 3.

### Example B2

70 g of terephthalic acid, 30 g of isophthalic acid, 339 g of trifluoromethanesulfonic acid, 315 g of trifluoroacetic anhydride, and 102 g of diphenyl ether were charged in this order into a four-necked separable flask equipped with a nitrogen inlet tube, a thermometer, a reflux cooling tube, and a stirrer, and stirred at 70° C. for 12 hours in a nitrogen atmosphere. After cooling to room temperature, the reaction solution was poured into vigorously stirred distilled water to precipitate a polymer, followed by filtration. The filtered polymer was washed twice with distilled water and ethanol. The polymer was then dried under vacuum at 160° C. for 8 hours.

The measurement and evaluation results are shown in Table 3.

### Example B3

60 g of terephthalic acid, 40 g of isophthalic acid, 339 g of trifluoromethanesulfonic acid, 315 g of trifluoroacetic anhydride, and 102 g of diphenyl ether were charged in this order into a four-necked separable flask equipped with a nitrogen inlet tube, a thermometer, a reflux cooling tube, and a stirrer, and stirred at 70° C. for 12 hours in a nitrogen atmosphere. After cooling to room temperature, the reaction solution was poured into vigorously stirred distilled water to precipitate a polymer, followed by filtration. The filtered polymer was washed twice with distilled water and ethanol. The polymer was then dried under vacuum at 160° C. for 8 hours.

The measurement and evaluation results are shown in Table 3.

### Example B4

80 g of terephthalic acid, 20 g of isophthalic acid, 339 g of trifluoromethanesulfonic acid, 315 g of trifluoroacetic anhydride, and 102 g of diphenyl ether were charged in this order into a four-necked separable flask equipped with a nitrogen inlet tube, a thermometer, a reflux cooling tube, and a stirrer, and stirred at 70° C. for 12 hours in a nitrogen atmosphere. After cooling to room temperature, the reaction solution was poured into vigorously stirred distilled water to precipitate a polymer, followed by filtration. The filtered polymer was washed twice with distilled water and ethanol. The polymer was then dried under vacuum at 160° C. for 8 hours.

The measurement and evaluation results are shown in Table 3.

### Comparative Example B1

### [Polymerization Example Using Acid Chloride Monomer and Anhydrous Aluminum Chloride Catalyst]

85 g of terephthalic acid dichloride, 37 g of isophthalic acid dichloride, 102 g of diphenyl ether, and 525 g of o-dichlorobenzene were charged into a four-necked separable flask equipped with a nitrogen inlet tube, a thermometer, a reflux cooling tube, and a stirrer, 204 g of anhydrous aluminum trichloride was added while maintaining the temperature at 5° C. or less in a nitrogen atmosphere, and the mixture was stirred at 0° C. for 30 minutes. After this, 2000 g of o-dichlorobenzene was added, and the mixture was stirred at 130° C. for 1 hour and then cooled to room temperature. The supernatant was removed by decantation, and the remaining reaction suspension was poured into vigorously stirred 2M hydrochloric acid to precipitate a polymer, followed by filtration. The filtered polymer was washed twice with distilled water and ethanol.

The measurement and evaluation results are shown in Table 4.

### Comparative Example B2

### [Polymerization Example Using Acid Chloride Monomer and Anhydrous Aluminum Chloride Catalyst]

73 g of terephthalic acid dichloride, 49 g of isophthalic acid dichloride, 102 g of diphenyl ether, and 525 g of o-dichlorobenzene were charged into a four-necked separable flask equipped with a nitrogen inlet tube, a thermometer, a reflux cooling tube, and a stirrer, 204 g of anhydrous aluminum trichloride was added while maintaining the temperature at 5° C. or less in a nitrogen atmosphere, and the mixture was stirred at 0° C. for 30 minutes. After this, 2000 g of o-dichlorobenzene was added, and the mixture was stirred at 130° C. for 1 hour and then cooled to room temperature. The supernatant was removed by decantation, and the remaining reaction suspension was poured into vigorously stirred 2M hydrochloric acid to precipitate a polymer, followed by filtration. The filtered polymer was washed twice with distilled water and ethanol.

The measurement and evaluation results are shown in Table 4.

### Comparative Example B3

### [Polymerization Example Using Acid Chloride Monomer and Anhydrous Aluminum Chloride Catalyst]

97.6 g of terephthalic acid dichloride, 24.4 g of isophthalic acid dichloride, 102 g of diphenyl ether, and 525 g of o-dichlorobenzene were charged into a four-necked separable flask equipped with a nitrogen inlet tube, a thermometer, a reflux cooling tube, and a stirrer, 204 g of anhydrous aluminum trichloride was added while maintaining the temperature at 5° C. or less in a nitrogen atmosphere, and the mixture was stirred at 0° C. for 30 minutes. After this, 2000 g of o-dichlorobenzene was added, and the mixture was stirred at 130° C. for 1 hour and then cooled to room temperature. The supernatant was removed by decantation, and the remaining reaction suspension was poured into vigorously stirred 2M hydrochloric acid to precipitate a polymer, followed by filtration. The filtered polymer was washed twice with distilled water and ethanol.

The measurement and evaluation results are shown in Table 4.

### Comparative Example B4

As the PEKK resin of Comparative Example B4, KEPSTAN7002: PEKK manufactured by Arkema S.A. was prepared. The measurement and evaluation results are shown in Table 4.

### Comparative Example B5

As the PEKK resin of Comparative Example B5, PEKK manufactured by Goodfellow was prepared. The measurement and evaluation results are shown in Table 4.

### Comparative Example B6

As the PEKK resin of Comparative Example B6, a PEKK resin was synthesized by the same method as in Comparative Example A9.

### Comparative Example B7

As the PEKK resin of Comparative Example B7, a PEKK resin was synthesized by the same method as in Comparative Example A10.

As shown in Table 3, the PAEK resins of Examples B1 to B4 were able to be adjusted to have a glass transition temperature (Tg) of 140° C. or more and a crystal melting point (Tm) of 310° C. or more, and were resins excellent in heat resistance substantially equivalent to commercially available PAEK resins (Comparative Examples B4 and B5 in Table 4).

In particular, the PAEK resins of Examples B1 to B4 improved in stress at the upper yield point as compared with Comparative Examples B1 to B7. These results indicate that the crystalline melting enthalpy change (ΔH) of each of the PAEK resins of Examples B1 to B4 improved as compared with Comparative Examples B1 to B7 having the same repeated composition, contributing to improved stress at the upper yield point of the resin.

Upon examination on such a temperature decrease rate after the temperature increase to 400° C. that is necessary for maximizing the crystal melting enthalpy change (AH) by DSC measurement, a higher temperature decrease rate maximizes the crystal melting enthalpy change (ΔH) in Examples B1 to B4 than in Comparative Examples B1 to B7. These results indicate that the crystallization rate for providing the maximum crystallinity was higher in the PAEK resins of Examples B1 to B4 than in the PAEK resins of Comparative Examples B1 to B7. A PAEK resin whose crystallization rate for providing the maximum crystallinity is high is industrially advantageous because the injection cycle time during molding is shortened and thus the time required to obtain the molded product is shortened.

The results of the chemical resistance evaluation test demonstrate that, in the evaluation of each of the chemical resistance (A) and the chemical resistance (B), the time taken for complete dissolution was improved in the samples of Examples B1 to B4 as compared with the samples of Comparative Examples B1 to B7. For the chemical resistance (B), the time taken for complete dissolution was significantly improved. These results seem to be derived from the improvement of the crystallinity of the PAEK resins of Examples B1 to B4 regardless of whether before or after the heat history. In particular, the remarkable improvement in the time taken for complete dissolution after the heat history is considered to be because the PAEK resins of Examples B1 to B4 significantly improved in crystallinity as a result of the heat history and exhibited remarkable chemical resistance.

Moreover, in Examples B1 to B4, PAEK resins with high strength and high crystallinity were obtained without using a nucleating agent. Thus, high strength and chemical resistance can be achieved without adding extra components. Such techniques are economically advantageous and, from the viewpoint of material recycling, highly versatile when reusing high-strength, high-heat-resistant thermoplastic resin.

TABLE 3 TABLE 3

| | | Unit | Example B1 | Example B2 | Example B3 | Example B4 |
|---|---|---|---|---|---|---|
| Composition | Repeating unit | mol % | 70 | 70 | 60 | 80 |
| | (1-1) | | | | | |
| | Repeating unit | mol % | 30 | 30 | 40 | 20 |
| | (2-1) | | | | | |
| | Number of ketone groups | mol % | 9.9 | 10.0 | 10.0 | 10.1 |
| | in repeating units | | | | | |
| | Number of ether groups | mol % | 5.0 | 5.1 | 4.9 | 5.0 |
| | in repeating units | | | | | |
| Reaction | (1-2) | g | 70 | 70 | 60 | 80 |
| conditions | (2-2) | g | 30 | 30 | 40 | 20 |
| | (3-1) | g | 102 | 102 | 102 | 102 |
| | (4-1)R¹, R² = F | g | 339 | 339 | 339 | 339 |
| | (5-1)R¹, R² = F | g | 315 | 315 | 315 | 315 |
| | Reaction temperature | ° C. | 40 | 70 | 70 | 70 |
| | Reaction time | hr | 12 | 12 | 12 | 12 |
| Analysis | Tm | ° C. | 344 | 344 | 315 | 359 |
| values | Tg | ° C. | 149 | 149 | 149 | 148 |
| | Tc | ° C. | 258 | 258 | 224 | 289 |
| | ΔH | J/g | 40 | 40 | 37 | 46 |
| | Tm-Tc | ° C. | 86 | 86 | 91 | 70 |
| | Temperature decrease rate | ° C./min | 20 | 20 | 20 | 20 |
| | that maximizes ΔH | | | | | |
| | Mn | — | 8200 | 10100 | 9800 | 10300 |
| | Mw/Mn | — | 1.8 | 2.3 | 2.1 | 2.1 |
| | Ratio of low molecular | % | 2.9 | 1.5 | 1.8 | 1.4 |
| | weight components | | | | | |
| | Fluorine atom content | mass ppm | 210.0 | 186.0 | 197.0 | 202.0 |
| | Aluminum atom content | mass ppm | 1.0 | 1.0 | 1.0 | 1.0 |
| | Chlorine atom content | mass ppm | 1.0 | 1.0 | 1.0 | 1.0 |
| | Tensile strength | MPa | 138.0 | 140.0 | 130.0 | 150.0 |
| | (stress at upper yield point) | | | | | |
| | Charpy impact strength | kJ/m² | 6.5 | 7.0 | 6.5 | 8.0 |
| | | — | ◯ | ⊚ | ◯ | ⊚ |
| | Chemical resistance (A) | hr | 1.0 | 1.0 | 0.8 | 1.2 |
| | Chemical resistance (B) | hr | 2.5 | 2.5 | 2.0 | 3.0 |

TABLE 4 TABLE 4

| | | | Compar- | Compar- | Compar- | Compar- | Compar- | Compar- | Compar- |
|---|---|---|---|---|---|---|---|---|---|
| | | | ative | ative | ative | ative | ative | ative | ative |
| | | | Example | Example | Example | Example | Example | Example | Example |
| | | Unit | B1 | B2 | B3 | B4 | B5 | B6 | B7 |
| Composition | Repeating unit | mol % | 70 | 60 | 80 | 70 | 80 | 70 | 70 |
| | (1-1) | | | | | | | | |
| | Repeating unit | mol % | 30 | 40 | 20 | 30 | 20 | 30 | 30 |
| | (2-1) | | | | | | | | |
| | Number of ketone groups | mol % | 9.9 | 9.6 | 9.9 | 10.1 | 10.0 | 9.9 | 9.9 |
| | in repeating units | | | | | | | | |
| | Number of ether groups | mol % | 10.1 | 5.0 | 5.1 | 4.9 | 4.9 | 5.0 | 5.0 |
| | in repeating units | | | | | | | | |
| Analysis | Tm | ° C. | 331 | ND | 360 | 331 | 363 | 330 | 331 |
| values | Tg | ° C. | 161 | 160 | 159 | 161 | 158 | 150 | 160 |
| | Tc | ° C. | 227 | ND | 305 | 227 | 308 | 223 | 222 |
| | ΔH | J/g | 35 | ND | 39 | 35 | 40 | 26 | 27 |
| | Tm-Tc | ° C. | 104 | — | 55 | 104 | 55 | 107 | 109 |
| | Temperature decrease rate | ° C./min | 10 | — | 18 | 10 | 18 | 18 | 18 |
| | that maximizes ΔH | | | | | | | | |
| | Mn | — | 8200 | 8000 | 8400 | 8700 | 9300 | 5100 | 9000 |
| | Mw/Mn | — | 2.6 | 2.8 | 3.2 | 2.6 | 3.7 | 1.9 | 6.3 |
| | Ratio of low molecular | % | 3.5 | 4.1 | 5.1 | 4.7 | 5.9 | 10.1 | 6.5 |
| | weight components | | | | | | | | |
| | Fluorine atom content | mass ppm | 15.0 | 16.0 | 19.0 | 16.0 | 18.0 | 310.0 | 3500.0 |
| | Aluminum atom content | mass ppm | 195.0 | 190.0 | 205.0 | 190.0 | 200.0 | 5.0 | 105.0 |
| | Chlorine atom content | mass ppm | 2000.0 | 1950.0 | 2500.0 | 4000.0 | 4000.0 | 20.0 | 200.0 |
| | Tensile strength | MPa | 115.0 | 75.0 | 130.0 | 120.0 | 130.0 | 100.0 | 120.0 |
| | (stress at upper yield point) | | | | | | | | |
| | Charpy impact strength | kJ/m² | 4.5 | 4.0 | 4.5 | 4.5 | 4.5 | 4.5 | 4.5 |
| | | — | Δ | x | Δ | Δ | Δ | Δ | Δ |
| | Chemical resistance (A) | hr | 0.5 | 0.1 | 0.6 | 0.5 | 0.6 | 0.1 | 0.6 |
| | Chemical resistance (B) | hr | 1.5 | 0.5 | 1.8 | 1.5 | 1.8 | 1.2 | 1.8 |

ND: Not Detected

1. A polyarylene ether ketone resin, wherein a GPC-based number average molecular weight Mn is 6000 or more and less than 16000,
a molecular weight distribution Mw/Mn represented by a ratio of a GPC-based weight average molecular weight Mw to the number average molecular weight Mn is 2.5 or less, and
in all repeating units contained in the resin, ketone groups are 9.5 mol % or more and ether groups are 4.5 mol % or more.

2. The polyarylene ether ketone resin according to claim 1, wherein the number average molecular weight Mn is 6000 or more and less than 13000, and
the molecular weight distribution Mw/Mn is 2.4 or less.

3. The polyarylene ether ketone resin according to claim 1, wherein when differential scanning calorimetry is performed by a conditional program of increasing from 50° C. to 400° C. under a temperature increase condition of 20° C./min and decreasing from 400° C. to 50° C. under a temperature decrease condition of 20° C./min in accordance with ASTM D3418, a crystal melting point (Tm) and a crystallization temperature (Tc) detected in a second program cycle after measurement start satisfy the following relationship:
60° C.≤(Tm−Tc)≤100° C.

4. The polyarylene ether ketone resin according to claim 1, comprising a repeating unit (1-1) represented by the following general formula (1-1) and optionally further comprising a repeating unit (2-1) represented by the following general formula (2-1),
wherein a ratio of the repeating unit (1-1) and the repeating unit (2-1), expressed as the repeating unit (1-1): the repeating unit (2-1), is in a range of 100:0 to 50:50 in molar ratio,

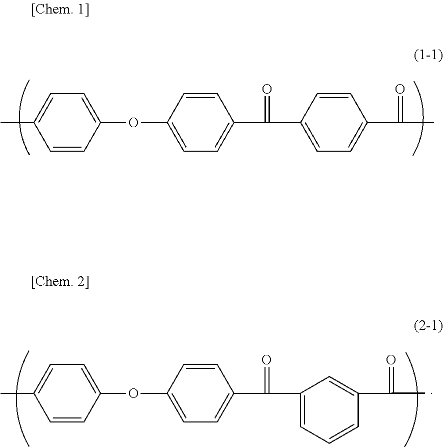

5. The polyarylene ether ketone resin according to claim 1, wherein a glass transition temperature is 140° C. or more, and a melting point is 300° C. or more.

6. The polyarylene ether ketone resin according to claim 1, wherein a fluorine atom content is 1500 mass ppm or less.

7. The polyarylene ether ketone resin according to claim 1, wherein in a differential molecular weight distribution curve obtained by GPC measurement, a ratio of an area of a part in which a molecular weight logarithmic value log M is 3.4 or less to an area of the entire curve is less than 8%, where M is a molecular weight.

8. The polyarylene ether ketone resin according to claim 1, wherein a tensile breaking strength is 110 MPa to 145 MPa.

9. The polyarylene ether ketone resin according to claim 1, wherein a Charpy impact strength is 5 kJ/m² or more.

10. The polyarylene ether ketone resin according to claim 1, wherein a ratio of the repeating unit (1-1) and the repeating unit (2-1), expressed as the repeating unit (1-1):the repeating unit (2-1), is in a range of 85:15 to 55:45 in molar ratio.

11. The polyarylene ether ketone resin according to claim 1, wherein when differential scanning calorimetry is performed by a conditional program of increasing from 50° C. to 400° C. under a temperature increase condition of 20° C./min and decreasing from 400° C. to 50° C. under a temperature decrease condition of 20° C./min in accordance with ASTM D3418, a crystal melting enthalpy change (ΔH) detected in a second program cycle after measurement start is 30 J/g or more.

12. The polyarylene ether ketone resin according to claim 1, wherein the crystallization temperature (Tc) is 220° C. or more.

13. A production method for a polyarylene ether ketone resin, comprising
reacting a monomer component containing a monomer having a phthaloyl skeleton with a Lewis acid or a Broensted acid anhydride catalyst in a solvent at 10° C. or more for 1 hour or more, and thereafter adding diphenyl ether (3-1) represented by the following general formula (3-1) to a resultant reaction product to react with the reaction product,
wherein in the polyarylene ether ketone resin, a GPC-based number average molecular weight Mn is 6000 or more and less than 16000, a molecular weight distribution Mw/Mn represented by a ratio of a GPC-based weight average molecular weight Mw to the number average molecular weight Mn is 2.5 or less, and in all repeating units contained in the resin, ketone groups are 9.5 mol % or more and ether groups are 4.5 mol % or more,

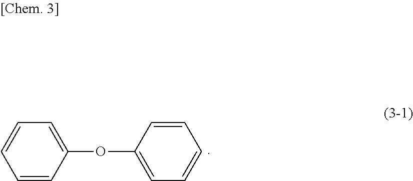

14. The production method for a polyarylene ether ketone resin according to claim 13, wherein the monomer component containing the monomer having the phthaloyl skeleton is a monomer component that contains a monomer (1-2) having a terephthaloyl skeleton represented by the following general formula (1-2) and optionally further contains a monomer (2-2) having an isophthaloyl skeleton represented by the following general formula (2-2), 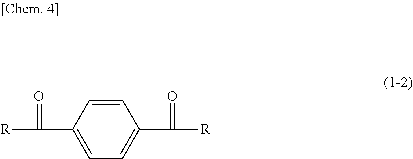
where R may be same or different, and are each a halogen atom or a hydroxy group, 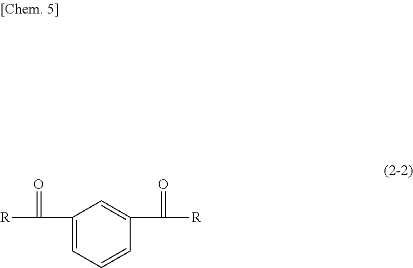
where R may be same or different, and are each a halogen atom or a hydroxy group.

15. The production method for a polyarylene ether ketone resin according to claim 13, wherein the Lewis acid is aluminum chloride.

16. The production method for a polyarylene ether ketone resin according to claim 13, wherein the Broensted acid anhydride catalyst is trifluoroacetic anhydride.

17. The production method for a polyarylene ether ketone resin according to claim 13, wherein the solvent is o-dichlorobenzene, chloroform, dichloromethane, trifluoromethanesulfonic acid, or trifluoroacetic acid.

18. A composition comprising the polyarylene ether ketone resin according to claim 1.

19. A molded product comprising the polyarylene ether ketone resin according to claim 1.

20. A molded product comprising the composition according to claim 18.
